(19) United States
(12) Patent Application Publication
(10) Pub. No.: US 2017/0289529 A1
(43) Pub. Date: Oct. 5, 2017

(54) ANAGLYPH HEAD MOUNTED DISPLAY

(71) Applicant: Google Inc., Mountain View, CA (US)

(72) Inventors: Jerome CAROLLO, San Francisco, CA (US); Rudy SEVILE, Santa Clara, CA (US)

(21) Appl. No.: 15/084,003

(22) Filed: Mar. 29, 2016

(51) Int. Cl. H04N 13/04; G02B 27/22

(52) U.S. Cl. CPC H04N 13/044; H04N 13/0422; H04N 13/0497; G02B 27/2207

(57) ABSTRACT

In one general aspect, a binocular anaglyph head mounted display (HMD) device can include a first monocular including a first display device and a first optical system. The first display device can be a single color display device configured to display image content on the first display device in a first color. The binocular anaglyph head mounted display (HMD) device can include a second monocular including a second display device and a second optical system. The second display device can be a two color display device configured to display image content on the second display device in a second color that is chromatically opposite to the first color.

### TECHNICAL FIELD

This description generally relates to display technology used in interactive head-mounted display (HMD) devices.

### BACKGROUND

There can be a multitude of benefits to a user as the performance and characteristics of HMD devices are improved. These improvements can enhance a user's VR experience when wearing the HMD device. For example, the improvements can make the HMD device more comfortable to wear. In addition, the improvements can result in a lower cost HMD device that does not compromise the user experience while wearing the HMD device.

### SUMMARY

In one general aspect, a binocular anaglyph head mounted display (HMD) device can include a first monocular including a first display device and a first optical system. The first display device can be a single color display device configured to display image content on the first display device in a first color. The binocular anaglyph head mounted display (HMD) device can include a second monocular including a second display device and a second optical system. The second display device can be a two color display device configured to display image content on the second display device in a second color that is chromatically opposite to the first color.

Implementations can include one or more of the following features, alone or in combination with one or more other features. For example, the first optical system can include a monochrome lens configured to provide the image content in the first color. The second optical system can include a two-color lens configured to provide the image content in the second color. The first display device and the second display device can be organic light-emitting diode (OLED) display devices. The first display device and the second display device can be liquid crystal display (LCD) devices. The binocular anaglyph HMD device can further include a computing device configured to generate, from original image content, the image content for display on the first display device in the first color and the image content for display on the second display device in the second color. The binocular anaglyph HMD device can further include a computing device configured to provide the image content for display in the first color to the first display device while providing the image content for display in the second color to the second display device. A first pixel displayed on the first display device can include a plurality of first subpixels. A second pixel displayed on the second display device can include a plurality of second subpixels. The plurality of first subpixels can be displayed in the first color. The second color can include a third color and a fourth color. A first subset of the plurality of second subpixels can be displayed in the third color. A second subset of the plurality of second subpixels can be displayed in the fourth color. The plurality of first subpixels can be arranged in a stripe pattern, the plurality of second subpixels can be arranged in a stripe pattern, the first color can be green, the second color can be magenta, the third color can be blue, and the fourth color can be red. The plurality of first subpixels can be arranged in a quad pattern, the plurality of second subpixels can be arranged in a quad pattern, the first color can be green, the second color can be magenta, the third color can be blue, and the fourth color can be red.

In another general aspect, a method can include generating, by a computing device and from original image content, a first color-filtered image including the original image content in a first color and a second color-filtered image including the original image content in a second color chromatically opposite to the first color, providing, by the computing device, the first color-filtered image in the first color for display on a first display device included in a first monocular of an anaglyph binocular head mounted display (HMD) device, and providing, by the computing device, the second color-filtered image in the second color for display on a second display device included in a second monocular of the anaglyph binocular HMD device, the first color-filtered image and the second color-filtered image when fused together providing a perception of the original image content.

Implementations can include one or more of the following features, alone or in combination with one or more other features. For example, the computing device can provide the first color-filtered image in the first color for display on the first display device simultaneously with providing the second color-filtered image in the second color for display on the second display device. Fusing together the first color-filtered image and the second color-filtered image can include overlapping the first color-filtered image and the second color-filtered image. The first color can be green, the second color can be magenta.

In yet another general aspect, a system can include a first display device configured to display image content in a first color, a second display device configured to display image content in a second color chromatically opposite to the first color, and a computing device. The computing device can include an image color separator configured to generate, from original image content, a first color-filtered image including the original image content in the first color and a second color-filtered image including the original image content in the second color chromatically opposite to the first color, and a display interface configured to provide the first color-filtered image for display on the first display device while providing the second color-filtered image for display on the second display device, the first color-filtered image when fused with the second color-filtered image providing a perception of the original image content.

Implementations can include one or more of the following features, alone or in combination with one or more other features. For example, the first display device and the second display device can be a single display device. The display interface can be further configured to provide the first color-filtered image for display on a first half of the single display device while providing the second color-filtered image for display on a second half of the single display device. The system can further include first optical system and a second optical system. The first optical system can be configured to provide the displayed first color-filtered image for fusing with the displayed second color-filtered image provided by the second optical system. The system can be a head mounted display (HMD) device. The computing device can be a mobile computing device. The single display device can be a screen of the mobile computing device.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example system that can incorporate the use of anaglyphs in an anaglyph head mounted display.

FIG. 2A is a diagram that illustrates an example system connecting a mobile computing device to an anaglyph HMD device using a cable.

FIG. 2B is a diagram that illustrates an example system connecting a mobile computing device to an anaglyph HMD device wirelessly using a wireless connection.

FIG. 3A is a diagram that illustrates an example anaglyph HMD device that includes a mobile computing device.

FIG. 3B is a diagram that shows an anaglyph HMD device being worn by a user.

FIG. 3C is a diagram that illustrates a binocular configuration for an anaglyph HMD device that uses a single display device.

FIG. 3D is a diagram that illustrates a binocular configuration for an anaglyph HMD device that uses two display devices.

FIG. 4 is a block diagram showing components included in an example computing device interfaced to and/or included in an anaglyph HMD device.

FIGS. 5A-D illustrate subpixels for a first color pixel and a second color pixel for display on a display device included in an anaglyph HMD device where the subpixels are arranged in a stripe pattern.

FIGS. 6A-C illustrate subpixels for a first color pixel and a second color pixel for display on a display device included in an anaglyph HMD device where the subpixels are arranged in a quad pattern.

FIG. 7 is a flowchart that illustrates a method of providing image content to an anaglyph binocular HMD device.

FIG. 8 is a diagram that illustrates an example of a computer device and a mobile computer device that can be used to implement the techniques described here.

Like reference symbols in the various drawings indicate like elements.

### DETAILED DESCRIPTION

Improvements in the performance and characteristics of HMD devices can include, but are not limited to, an increase in a field of view for the HMD device; an increase in the resolution of three dimensional (3D) images displayed by a display device included in the HMD device; a reduction in the amount of power used by (consumed by) the HMD device; a reduction in the bandwidth needed to provide a virtual reality (VR) experience by the HMD device; and a reduction in the size and weight of the HMD device (making the HMD device more comfortable for a user to wear).

For example, increasing the resolution of 3D images displayed by the display device included in the HMD device includes providing more pixels for display on the display device. Providing an increased number of pixels can include increasing the processing power of a computing device that executes (runs) the VR application. Increasing the processing power can result in an increase in a power consumption of the computing device. Providing an increased number of pixels can include increasing a complexity of a backplane of the display device. Providing an increased number of pixels can include increasing a resolution of the display device that displays the 3D images. Increasing the resolution of the display device can result in a larger display device. A larger display device can increase the size, weight, and complexity of the HMD device, which can result in an increase in the cost of the HMD device. In summary, though increasing the resolution of 3D images may be desirable in a VR space provided by an HMD device, it can result in many undesirable characteristics for the HMD device such as increased power consumption, increased size and weight, and increased cost.

For example, an increase in a field of view for the HMD device can require an increase in the acuity or sharpness provided by a display device included in the HMD device. These increases can complicate an HMD device system by requiring an increase in a bandwidth requirement for the computing device included in (or interfacing with) the HMD device and, in particular, by requiring an increase in a bandwidth requirement for the computing device interfacing with a display device included in the HMD device. The increased bandwidth can require the computing device to provide the display device with high refresh (high display update) rates that may be challenging in some systems. For example, in a system where the HMD device interfaces to a computing device using a wireless connection, the capability of the wireless connection may restrict (control) the available bandwidth. In another example, in a system where the computing device is integrated with (included within) the HMD device, a size and/or power consumption restriction on the computing device may restrict (control) the available bandwidth. The ability to achieve an increase in the resolution of 3D images displayed by the display device included in the HMD device and the ability to achieve an increase in a field of view for the HMD device at a lower bandwidth (without increasing the bandwidth) can be beneficial.

An HMD device can be connected to (interfaced with) a computing device. The computing device can run (execute) a VR application that can provide VR content to the HMD device. In some implementations, the computing device can be external to (separate from) the HMD device. In a first implementation, a cable can connect the computing device to the HMD device. In the first implementation, the HMD device can be tethered to the computing device. The first implementation can be referred to as a tethered HMD device. In a second implementation, the computing device can connect to the HMD device wirelessly (without a cable). In the second implementation, the HMD device can be untethered (not tethered) to the computing device. The second implementation can be referred to as an untethered HMD device.

The tethered HMD device and the untethered HMD device can connect to/communicate with a computing device using one or more high-speed wired and/or wireless communications protocols that can include, but are not limited to, WiFi, Bluetooth, Bluetooth Low Energy (LE), Universal Serial Bus (USB), USB 3.0, and USB Type-C. In addition, or in the alternative, the HMD device can connect to/communicate with the computing device using an audio/video interface such as High-Definition Multimedia Interface (HDMI).

In some implementations, the computing device be included in (be part of, be housed within) the HMD device. For example, an HMD device that includes (houses) a computing device as part of the HMD device can be referred to as a mobile HMD device. In these implementations, the computing device can execute (e.g., run) the VR application in the mobile HMD device providing a mobile VP platform. In some implementations, the computing device can include a display device that displays 3D rendered images to the user of the mobile HMD device in the VR space. In some implementations, the computing device can connect to (interface with) a separate display device included in the mobile HMD device.

A computing device that executes (runs) a VR application in a mobile HMD device needs to provide the computing power necessary to provide a VR space and a mobile VR platform to a user. It is therefore beneficial to be able to increase the processing power and efficiency of the computing device while maintaining or decreasing the power consumed by the computing device.

Anaglyphs can provide a stereoscopic 3D effect to a user viewing an image. An anaglyph 3D image can include two differently filtered colored images for viewing by each eye of a user. A user can view an anaglyph 3D image through color-coded filters placed in front of each eye of the user. The filters can be different colors (e.g., chromatically opposite colors). For example, an anaglyph 3D image can include a red filtered image and a cyan filtered image. A red color filter can be placed in front of a right eye of a user to allow the user to see or view the red filtered image. A cyan (green-blue) color filter can be placed in front of a left eye of the user to allow the user to see or view the cyan filtered image. Of course, in some cases, the placement of the color filters in front of the eyes of the user can be swapped (e.g., red color filter placed in front of a right eye of a user, cyan color filter placed in front of a left eye of a user).

In the described example, red and cyan color filters are used. In other examples and implementations, different color filters can be used. In one example implementation, one color filter can be a blue color filter and the other color filter can be a yellow color filter. In another example implementation, one filter can be a green color filter and the other filter can be a magenta color filter.

Each eye of the user is provided with an encoding of the anaglyph 3D image based on the color filter located in front of the eye of the user. Each color-coded image as viewed by each eye of the user through each respective color filter provides the user with an integrated stereoscopic image. A visual cortex of a brain of the user fuses or combines the images included in the integrated stereoscopic image to provide the user with the perception of viewing a 3D scene (a 3D space or a 3D image composition).

Anaglyphs can provide a stereoscopic 3D effect to a user viewing an image or scene on a screen or other flat, two-dimensional display device. The display device can present (display) the scene as two superimposed images (e.g., a first image superimposed on a second image). Each image can represent a view of the image by each eye of the user. The first image can represent the image as viewed by (provided to, received by) the right eye of the user through a first color filter (e.g., a red color filter). The second image can represent the image as viewed by (provided to, received by) the left eye of the user through a second color filter (e.g., a cyan color filter). By placing a respective filter in front of each eye of the user, a visual cortex of a brain of the user can fuse or combine the first image and the second image to provide the user with the perception of viewing the scene in three-dimensions.

The techniques used to provide anaglyphs could be applied to providing a full color 3D VR experience to a user wearing a HMD device. As described, a visual cortex of a brain of a user can fuse or combine images provided in chromatically opposite colors to each eye of the user into a perception of a 3D scene. In some implementations, an HMD device can include a display device and associated optics for each image provided to an eye of a user. The display devices and associated optics can provide the images to the eyes of the user in a binocular configuration. The binocular configuration can include two independent optical monoculars where each optical monocular includes a display device and associated optics. A scene for viewing in full color in the 3D VR space can be separated into two images that can be superimposed. The first image can be displayed on a first display device in a first color. The second image can be displayed on a second display device in a second color that is chromatically opposite to the first color.

The first image and the second image include the same image content represented in different colors. The first image and the second image can essentially overlap one another (e.g., nearly completely overlap one another, nearly 100% overlap). Overlapping the first image and the second image produces (results in) the original scene or image. Overlaying the first image over the second image or overlaying the second image over the first image can produce (reproduce) the original scene or image. Then each eye of the user (e.g., a left eye and a right eye) sees the same image (the same image content) just in a different color. In addition, each eye of the user (e.g., a left eye and a right eye) sees the same field of view for the image. A visual cortex of a brain of a user viewing each display device through the associated optics can fuse or combine (overlay, overlap, join, blend) the first image and the second image into a perception of the original image in the VR space.

The use of anaglyphs in a HMD device can provide a user with a full color 3D image or scene in a VR space from two images provided by two independent color channels. The anaglyphs in a HMD device does not require providing a full color image of the scene to each eye of a user. As such, one or more technical benefits can be achieved by providing two display devices in a HMD device where each display device does not need to display a full color (three-color) image. As described in the examples and cases included herein, a first display device can be a monochrome (one-color) display device and a second display device can be a two-color display device. The colors of the second display device are selected to display an image in a color that is chromatically opposite to the color of the image displayed by the first display device.

In a first case, the use of anaglyphs in a HMD device that includes two display devices can provide a higher luminance level for the display devices at a particular power consumption for the HMD device that previously provided a lower luminance level for a single display device included in the HMD device. In a second case, the use of anaglyphs in a HMD device that includes two display devices can reduce the power consumption of the HMD device while maintaining a particular luminance level for the display devices that was the luminance level previously provided by a single display device included in the HMD device. In both the first and second cases, these benefits can be achieved because each display device does not need to display a full color (three-color) image. As such, simpler color filters, backlights, and organic materials can be incorporated into each of the separate display devices as compared to a single three-color display device. In addition, a lifetime associated with each of the separate display devices can be higher as compared to a lifetime associated with a single three-color display because of the use of reduced power in the HMD device. This can also reduce the cost of each separate display device such that their combined cost can be less than the cost of a single three-color display device.

In a third case, the use of anaglyphs in a HMD device can incorporate single color and dual color (two-color) display devices in the HMD device as compared to the use of three color display devices. For example, in an HMD device that provides a red color image to one eye of a user and a cyan (blue-green) color image to another eye of the user using two different display devices, a first display device can be a monochrome display device that provides the red color component of the image information and a second display device can be a two color display device that provides the blue and green color components of the image information.

The third case can provide many system benefits because each display device does not need to provide a three-color image. A first benefit can be a reduction in the cost of each display device. A second benefit can be a reduction in the amount of sub-pixel and pixel cross talk in each display device. A third benefit can be the reduction in a bandwidth of the electronics used to interface to and to drive each of the display devices. A fourth benefit can be an improved color space because it is less complex to fine-tune a spectrum of a single color or a two-color display than a three-color display. A fifth benefit can be a reduction in the color filters needed to filter the colors from a three-color display. For example, a single color display (e.g., a display device that displays a red color image) and a two-color display (e.g., a display device that displays a cyan (blue-green) image) require no color filters. A sixth benefit can be a reduction in the complexity of the optics used in the HMD device. A seventh benefit can be an increase in the resolution of the image because since each display device does not need to provide a three-color image, in some implementations, a higher pixel density can be achieved.

In general, the use of anaglyphs in a HMD device (e.g., an anaglyph HMD device) can provide a user with a full color 3D image or scene in a VR space from two images provided by a first display device and a second display device. The first display device can be a monochrome (one-color) display device (e.g., a display device that displays red image content, a display device that displays green image content). The second display device can be a two-color display device (e.g., a display device that displays cyan (blue-green) image content, a display device that displays magenta (blue-red) image content, respectively). The anaglyph HMD device can use fifty percent less power than a non-anaglyph HMD device (an HMD device that uses a three-color display device). In addition or in the alternative, a central processing unit (CPU) and/or a graphics processing unit (GPU) included in the anaglyph HMD device can process fewer pixels than a CPU and/or a GPU included in a non-anaglyph HMD device. In addition or in the alternative, a CPU and/or a GPU included in the anaglyph HMD device can render only the color(s) needed on each display device reducing the power consumed by an anaglyph HMD device as compared to a non-anaglyph HMD device. In addition or in the alternative, a CPU and/or a GPU included in the anaglyph HMD device can provide system optimizations that can include as increase an update rate (reduce a lag) of the display devices included in an anaglyph HMD device. The anaglyph HMD device can provide these optimizations consuming essentially the same or even less power than a non-anaglyph HMD device that is not performing the optimizations.

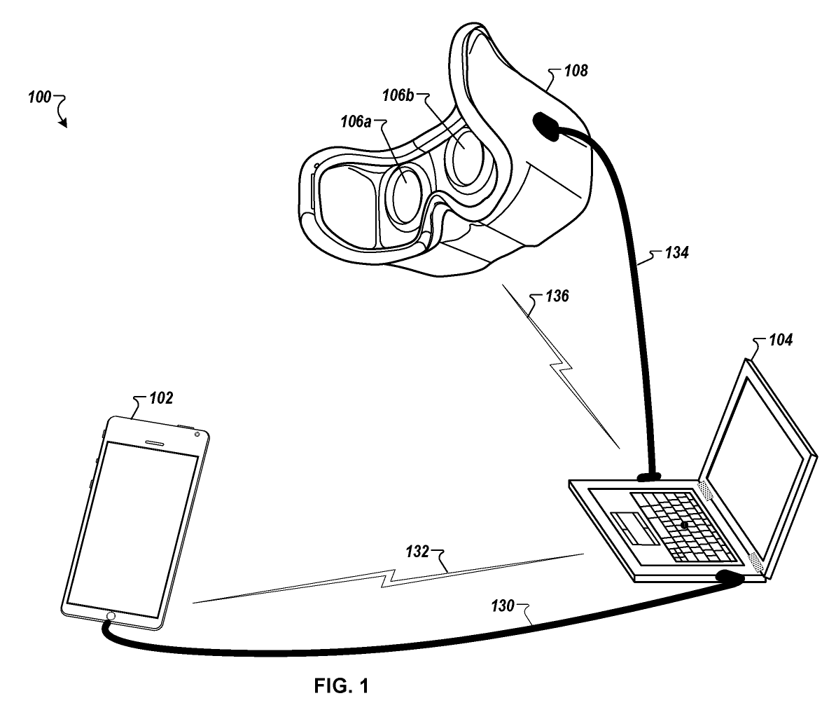

FIG. 1 is a diagram that illustrates an example system 100 that can incorporate the use of anaglyphs in an anaglyph head mounted display (an anaglyph HMD device 108). The use of the anaglyph HMD device 108 can provide a user with a full color 3D image or scene in a VR space. In some implementations, a visual cortex of a brain of a user can fuse or combine a first image as viewed through (provided by) a first monocular 106a and a second image as viewed through (provided by) a second monocular 106b, forming the 3D image or scene in the VR space. The first monocular 106a and the second monocular 106b can provide the first image and the second image, respectively, to each eye of the user in a binocular configuration as shown in FIG. 1.

In some implementations, the first monocular 106a can include a first display device and a first optical system and the second monocular 106b can include a second display device and a second optical system. In some implementations, the first monocular 106a can include a first optical system and the second monocular 106b can include a second optical system. The first optical system can provide image information to a first eye of a user from a first half of a display device included in the anaglyph HMD device 108. The second optical system can provide image information to a second eye of the user from a second half of the display device included in the anaglyph HMD device 108.

In the example system 100, a VR application can execute on a first computing device 102 and/or on a second computing device 104. The VR application can interface with a color-filtering application that can execute on the first computing device 102 and/or the second computing device 104. The color-filtering application can generate a first color-filtered image in a first color for displaying on a display for use in the first monocular 106a. The color-filtering application can generate a second color-filtered image in a second color for displaying on the display for use in the second monocular 106b. The second color can be chromatically opposite to the first color. The VR application using the anaglyph HMD device 108 can display the first color-filtered image in the first color on the display for use in the first monocular 106a while simultaneously displaying the second color-filtered image in the second color on the display for use in the second monocular 106b. The user can view the first color-filtered image and the second color-filtered image in the binocular configuration of the anaglyph HMD device 108. A visual cortex of a brain of the user can fuse or combine the first color-filtered image and the second color-filtered image, providing the user with the perception of viewing a full color scene in three-dimensions.

The second computing device 104 may be a laptop computer, a desktop computer, a mobile computing device, or a gaming console. In the implementation shown in FIG. 1, the anaglyph HMD device 108 can be connected to the second computing device 104. The second computing device 104 can be connected to the first computing device 102. The first computing device 102 may be used as a controller and/or interface device in a VR space.

The second computing device 104 can provide 3D image content for display in the anaglyph HMD device 108. The second computing device 104 can execute (run) a VR application that provides the appropriate 3D image content to the anaglyph HMD device 108. For example, the VR application can process the 3D image content for display in the anaglyph HMD device 108 by separating a full color image into a first image of a first color and a second image of a second color that is chromatically opposite to the first color. The VR application can prepare data representative of the first image and data representative of the second image. The representative data can be prepared for input to one or more display devices included in the anaglyph HMD device 108 as described herein.

In some implementations, the second computing device 104 can be connected to/interfaced with the first computing device 102 using a wired connection 130. In some implementations, the second computing device 104 can be connected to/interfaced with the first computing device 102 using a wireless connection 132. In some implementations, the second computing device 104 can be connected to/interfaced with the anaglyph HMD device 108 using a wired connection 134. In these implementations, the anaglyph HMD device 108 can be referred to as a tethered anaglyph HMD device. In some implementations, the second computing device 104 can be connected to/interfaced with the anaglyph HMD device 108 using a wireless connection 136. In these implementations, the anaglyph HMD device 108 can be referred to as an untethered anaglyph HMD device.

The wired connection 130 can include a cable with an appropriate connector on either end for plugging into the first computing device 102 and the second computing device 104. For example, the cable can include a Universal Serial Bus (USB) connector on both ends. The USB connectors can be the same USB type connector or the USB connectors can each be a different type of USB connector. The various types of USB connectors can include, but are not limited to, USB A-type connectors, USB B-type connectors, micro-USB A connectors, micro-USB B connectors, micro-USB AB connectors, USB five pin Mini-b connectors, USB four pin Mini-b connectors, USB 3.0 A-type connectors, USB 3.0 B-type connectors, USB 3.0 Micro B connectors, and USB C-type connectors. Similarly, the wired connection 134 can include a cable with an appropriate connector on either end for plugging into the anaglyph HMD device 108 and the second computing device 104. For example, the cable can include a Universal Serial Bus (USB) connector on both ends. The USB connectors can be the same USB type connector or the USB connectors can each be a different type of USB connector.

The first computing device 102 and/or the anaglyph HMD device 108 can wirelessly connect to/interface with the second computing device 104 using one or more high-speed wireless communication protocols such as, for example, WiFi, Bluetooth, or Bluetooth Low Energy (LE).

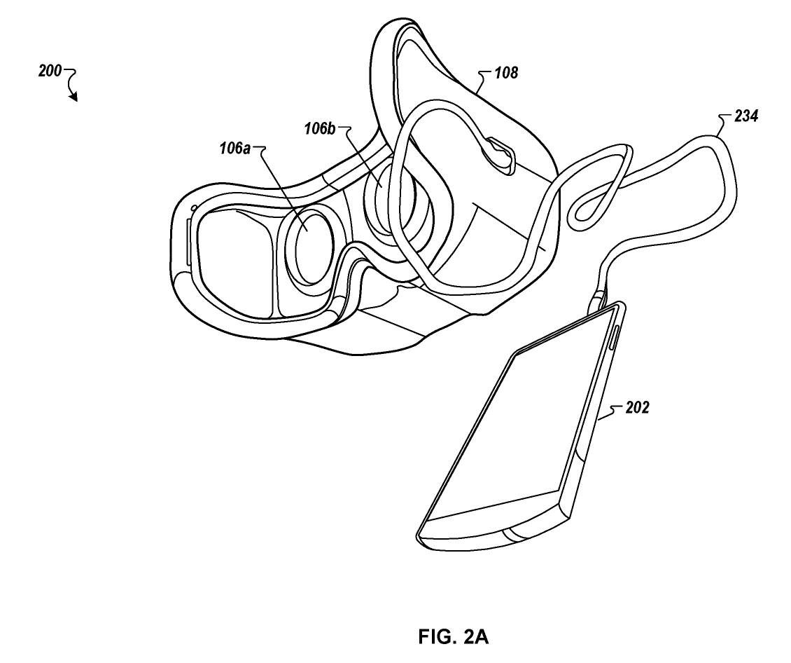

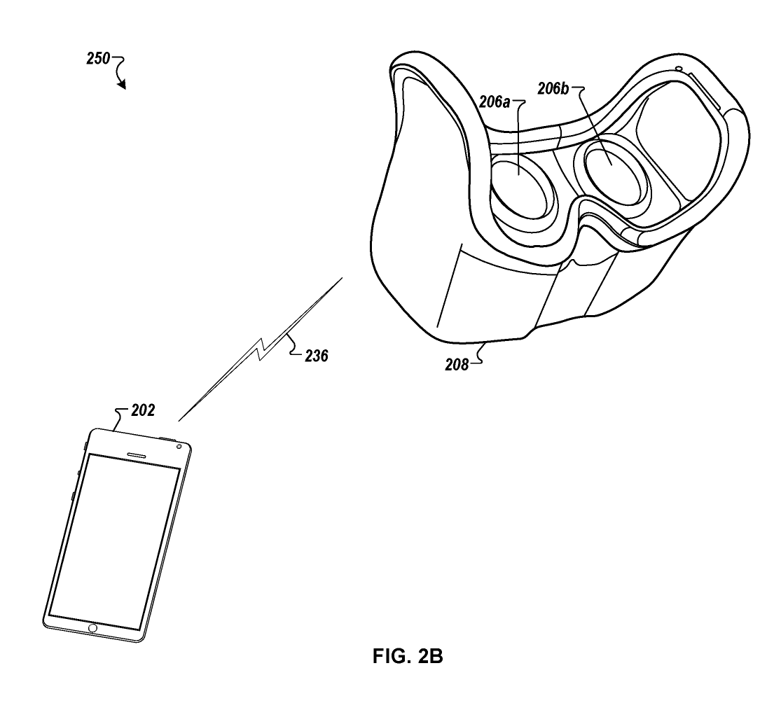

FIG. 2A is a diagram that illustrates an example system 200 connecting a mobile computing device (e.g., a mobile computing device 202) to an anaglyph HMD device (e.g., the anaglyph HMD device 108) using a cable (e.g., cable 234). The mobile computing device 202 can connect to/communicate with the anaglyph HMD device 108 using one or more high-speed communication protocols such as those described herein with reference to FIG. 1. In some cases, the mobile computing device 202 can connect to/communicate with the anaglyph HMD device 108 using an audio/video interface such as, for example, High-Definition Multimedia Interface (HDMI). In some cases, the mobile computing device 202 can connect to/communicate with the anaglyph HMD device 108 using a DisplayPort Alternate mode for a USB Type-C standard interface. The DisplayPort Alternate mode can include a high-speed USB communication interface and DisplayPort functions.

FIG. 2B is a diagram that illustrates an example system 250 connecting a mobile computing device (e.g., the mobile computing device 202) to an anaglyph HMD device (e.g., anaglyph HMD device 208) wirelessly using a wireless connection 236. The mobile computing device 202 can connect to/communicate with the anaglyph HMD device 208 wirelessly using one or more high-speed communication protocols such as, for example, WiFi, Bluetooth, or Bluetooth LE.

The mobile computing device 202 can provide 3D image content for display in the anaglyph HMD device 208. The mobile computing device 202 can execute (run) one or more VR applications that provide the appropriate 3D image content to the anaglyph HMD device 208. For example, the VR application(s) can process the 3D image content for display in the anaglyph HMD device 208. The VR application(s) can separate a full color image into a first image of a first color and a second image of a second color that is chromatically opposite to the first color. The VR application(s) can prepare data representative of the first image and data representative of the second image. The representative data can be prepared for input to one or more display devices included in the anaglyph HMD device 208 as described herein. A first monocular 206a can include a first display device and a first optical system and a second monocular 206b can include a second display device and a second optical system. The first optical system can provide image information to a first eye of a user from a first half of a display device (or a first display device) included in the anaglyph HMD device 208. The second optical system can provide image information to a second eye of the user from a second half of the display device (or a second display device) included in the anaglyph HMD device 208. The data representative of the first image and the data representative of the second image are simultaneously provided to the anaglyph HMD device 208 in real-time. The anaglyph HMD device 208 can display the image data on a single (or multiple) display devices included in the anaglyph HMD device 208 providing a VR experience in three dimensions to a user wearing the anaglyph HMD device 208.

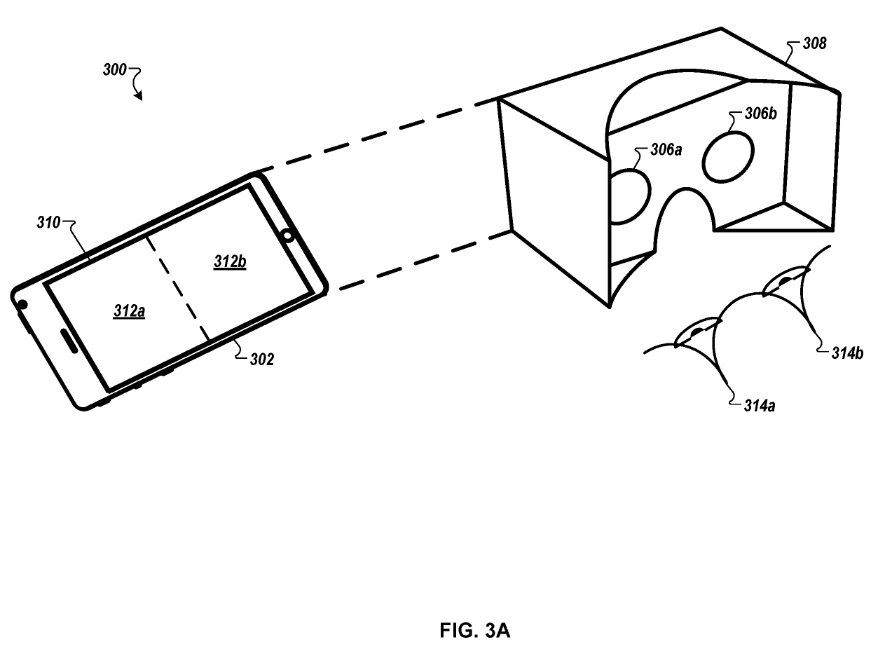

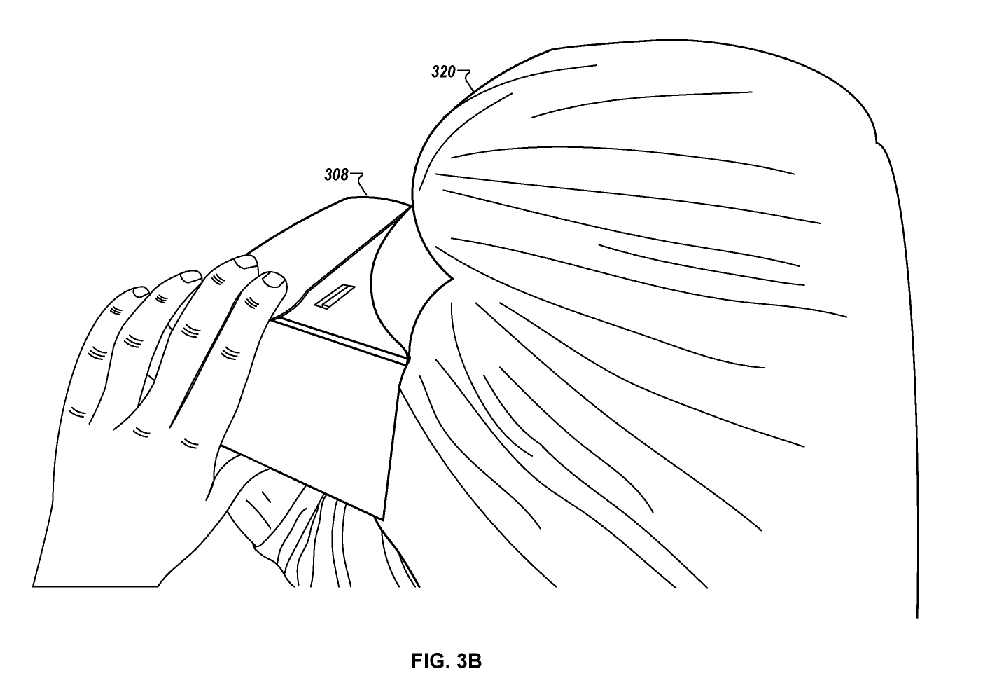

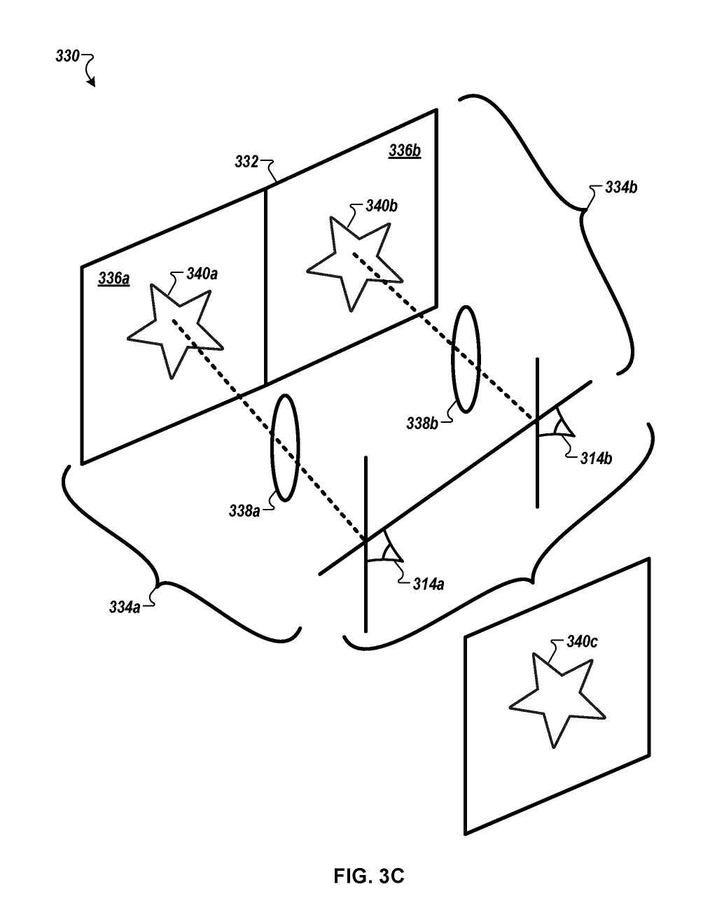

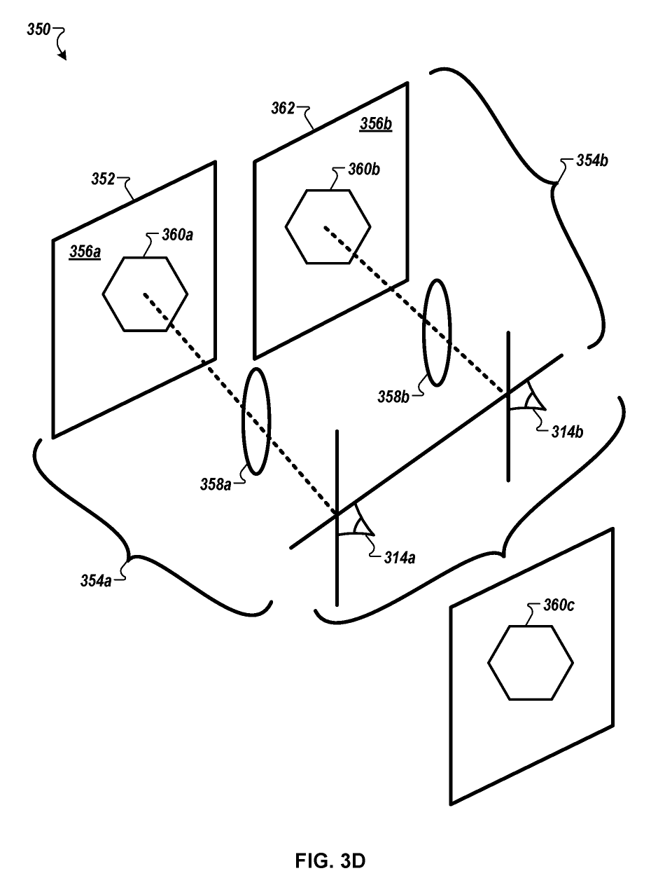

FIG. 3A is a diagram that illustrates an example anaglyph HMD device 308 that includes (incorporates, houses) a mobile computing device 302. In some implementations, the anaglyph HMD device 308 can include a removable computing device (e.g., the first computing device 102, the mobile computing device 202). For example, a mobile computing device of a user (e.g., the mobile computing device 302) can be placed inside of (within) the anaglyph HMD device 308 when the user wishes to immerse themselves in a VR space. In some implementations, a mobile computing device (e.g., the mobile computing device 302) can be permanently included (incorporated within, housed in) an anaglyph HMD device (e.g., the anaglyph HMD device 308). The mobile computing device 302 can execute one or more applications including a VR application. The mobile computing device 302 can be incorporated within (housed within, be part of) a casing or frame of the anaglyph HMD device 308. The anaglyph HMD device 308 can include two monoculars (e.g., a first monocular 306a and a second monocular 306b). The Examples of the first monocular 306a and the second monocular 306b will be shown in more detail with reference to, for example, FIGS. 3C-D.

FIG. 3B is a diagram that shows the anaglyph HMD device 308 being worn by a user 320. Referring to FIG. 3A, the user 320 can put on the anaglyph HMD device 308 that incorporates (includes) the mobile computing device 302 by placing the anaglyph HMD device 308 over the eyes (e.g., the first eye 314a and the second eye 314b) of the user 320. The mobile computing device 302 can include a display or screen (e.g., screen 310). In some implementations, the user can view the screen 310 when wearing the anaglyph HMD device 308 while immersed in the VR space. In some implementations, a first image can be displayed on a first half 312a of the screen 310 in a first color and a second image can be displayed on a second half 312b of the screen 310 in a second color that is chromatically opposite to the first color. The each eye 314a-b of the user 320 (e.g., the first eye 314a and the second eye 314b) sees the same image (the same image content) just in a different color. In addition, each eye 314a-b of the user 320 (e.g., the first eye 314a and the second eye 314b) sees the same field of view for the image. A visual cortex of a brain of the user 320 viewing each image through the associated optics can fuse or combine (overlay, overlap, join, blend) the first image and the second image into a perception of the original image in the VR space.

FIG. 3C is a diagram that illustrates a binocular configuration 330 for an anaglyph HMD device (e.g., the anaglyph HMD device 308) that uses a single display device 332. In some implementations, the single display device 332 can be the screen 310 of the mobile computing device 302. In some implementations, the single display device 332 can be different from the screen 310 of the mobile computing device 302. The mobile computing device 302 can connect to (interface with) the single display device 332. In some implementations, the mobile computing device 302 can interface to (connect to) the single display device 332 by way of a wired connection using, for example, one or more communication protocols as described herein. In some implementations, the mobile computing device 302 can interface to (connect to) the single display device 332 by way of a wireless connection using, for example, one or more communication protocols as described herein.

In some implementations, referring to FIG. 2A, the binocular configuration 330 can be for an anaglyph HMD device (e.g., the anaglyph HMD device 108) that uses a single display device, where the mobile computing device 202 is tethered to the anaglyph HMD device 108. In some implementations, referring to FIG. 2B, the binocular configuration 330 can be for an anaglyph HMD device (e.g., the anaglyph HMD device 108) that uses a single display device, where the mobile computing device 202 is tethered to the anaglyph HMD device 108. In some implementations, referring to FIG. 1, the binocular configuration 330 can be for an anaglyph HMD device (e.g., the anaglyph HMD device 108) that uses a single display device, where the second computing device 104 is connected to (interfaced with) the anaglyph HMD device 108 as described herein.

The binocular configuration 350 shows two monoculars (e.g., a first monocular 334a and a second monocular 334b). Each monocular 334a-b can be independent of one another. Each monocular 334a-b can include (interface with) a particular half or side of the single display device 332. The first monocular 334a includes (interfaces with) a first half (or side) 336a of the single display device 332. The second monocular 334b includes (interfaces with) a second half (or side) 336b of the single display device 332.

Each monocular 334a-b can include (interface with) associated optics. The first monocular 334a includes (interfaces with) a first optic (or lens) 338a. The second monocular 334b includes (interfaces with) a second optic (or lens) 338b.

The single display device 332 included in the anaglyph HMD device 308 can display a scene or image as two separate images (e.g., a first image 340a and a second image 340b). The binocular configuration 330 for the anaglyph HMD device 308 can allow the user 320 to view the scene or image in 3D and in full color in a VR space. The first image 340a can be displayed in the first half 336a of the single display device 332 in a first color (e.g., green). The second image 340b can be displayed in the second half 336b of the single display device 332 in a second color (e.g., magenta) that is chromatically opposite to the first color. Each of the first monocular 334a and the second monocular 334b can provide the first image 340a displayed on the first half 336a of the single display device 332 and the second image 340b displayed on the second half 336b of the single display device 332, respectively, to the first eye 314a and the second eye 314b, respectively, of the user 320 in the binocular configuration 330. A visual cortex of a brain of the user 320 can fuse or combine the first image 340a provided to the first eye 314a and the second image 340b image provided to the second eye 314b into a perception of a 3D image in the VR space (e.g., a third image 340c). For example, a green first image (e.g., the first image 340a) and a magenta second image (e.g., the second image 340b) combined can form a white third image (e.g., the third image 340c). In another example, a red first image (e.g., the first image 340a) and a cyan second image (e.g., the second image 340b) combined can form a white third image (e.g., the third image 340c).

FIG. 3D is a diagram that illustrates a binocular configuration 350 for an anaglyph HMD device that uses two display devices, a first display device 352 and a second display device 362. In some implementations, referring to FIG. 3A, the anaglyph HMD device can be the anaglyph HMD device 308 where the mobile computing device 302 is included within (placed within, placed inside of, incorporated within, housed within) the anaglyph HMD device. The mobile computing device 302 can connect to (interface with) the first display device 352 and the second display device 362. In some implementations, the mobile computing device 302 can interface to (connect to) the first display device 352 and the second display device 362 by way of a wired connection using, for example, one or more communication protocols as described herein. In some implementations, the mobile computing device 302 can interface to (connect to) the first display device 352 and the second display device 362 by way of a wireless connection using, for example, one or more communication protocols as described herein.

In some implementations, referring to FIG. 2A, the binocular configuration 350 can be for an anaglyph HMD device (e.g., the anaglyph HMD device 108) that uses two display devices, where the mobile computing device 202 is tethered to the anaglyph HMD device 108. In some implementations, referring to FIG. 2B, the binocular configuration 350 can be for an anaglyph HMD device (e.g., the anaglyph HMD device 108) that uses two display devices, where the mobile computing device 202 is tethered to the anaglyph HMD device 108. In some implementations, referring to FIG. 1, the binocular configuration 350 can be for an anaglyph HMD device (e.g., the anaglyph HMD device 108) that uses two display devices, where the second computing device 104 is connected to (interfaced with) the anaglyph HMD device 108 as described herein.

The binocular configuration 350 shows two monoculars (e.g., a first monocular 354a and a second monocular 354b). Each monocular 354a-b can be independent of one another. The first monocular 354a can include (interface with) the first display device 352. The second monocular 354b includes (interfaces with) the second display device 362. Each monocular 354a-b can include (interface with) associated optics. The first monocular 354a includes (interfaces with) a first optic (or lens) 358a. The second monocular 354b includes (interfaces with) a second optic (or lens) 358b.

The first display device 352 and the second display device 362 can display a scene or image as two separate images (e.g., a first image 360a and a second image 360b). The binocular configuration 350 for an anaglyph HMD device can allow a user (e.g., the user 320) to view a scene or image in 3D and in full color in a VR space. The first image 360a can be displayed on the first display device 352 in a first color (e.g., green). The second image 340b can be displayed on the second display device 362 in a second color (e.g., magenta) that is chromatically opposite to the first color. Each of the first monocular 354a and the second monocular 354b can provide the first image 360a displayed on the first display device 352 and the second image 360b displayed on the second display device 362, respectively, to the first eye 314a and the second eye 314b, respectively, of the user 320 in the binocular configuration 350. A visual cortex of a brain of a user (e.g., the user 320) can fuse or combine the first image 360a provided to the first eye 314a and the second image 360b image provided to the second eye 314b into a perception of a 3D image in the VR space (e.g., a third image 360c). For example, a green first image (e.g., the first image 360a) and a magenta second image (e.g., the second image 360b) combined can form a white third image (e.g., the third image 360c). In another example, a red first image (e.g., the first image 360a) and a cyan second image (e.g., the second image 360b) combined can form a white third image (e.g., the third image 360c).

Referring to FIGS. 3C-D, the first optic 338a and the first optic 358a can be implemented as monochrome lenses (lenses configured to provide the first image 340a and the first image 340a, respectively, in the first color to the first eye 314a of a user). The use of monochrome lenses in an optical monocular included in an anaglyph HMD device can reduce the cost and/or weight of the anaglyph HMD device as compared to a HMD device that does not implement the use of anaglyphs. The second optic 338b and the second optic 358b can be implemented as two-color lenses (lenses configured to provide the second image 340b and the second image 360b, respectively, in the second color, that is chromatically opposite to the first color, to the second eye 314b of a user). The use of two-color lenses in an optical monocular included in an anaglyph HMD device can also reduce the cost and/or weight of the anaglyph HMD device as compared to a HMD device that does not implement the use of anaglyphs. An HMD device that does not implement the use of anaglyphs provides full color images to each eye of a user requiring the use of multiple and/or more complex optical elements in each optical monocular included in the HMD device. The multiple and/or more complex optical elements can be more expensive and heavier as compared to a monochrome lens.

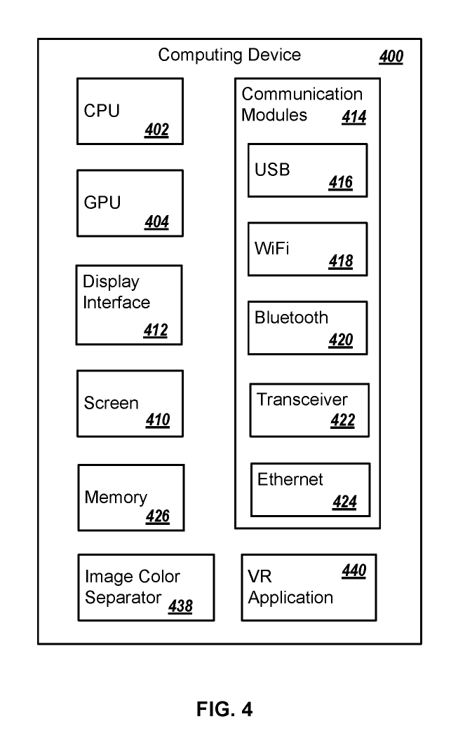

FIG. 4 is a block diagram showing components included in an example computing device 400 interfaced to and/or included within (housed in, incorporated in) an anaglyph HMD device. Referring to FIGS. 1, 2A-B, and 3A-D, the computing device 400 can be the first computing device 102, the second computing device 104, the mobile computing device 202, and/or the mobile computing device 302. The computing device 400 can include circuity and software (applications) that can generate and provide appropriate images (image data and information) to one or more display devices (e.g., a single display device, two display devices) included in an anaglyph HMD device (e.g., the anaglyph HMD device 108, the anaglyph HMD device 208, the anaglyph HMD device 308). In some implementations, a screen 410 included in the computing device 400 can be the display device for the anaglyph HMD device as described with reference to FIGS. 3A-C.

The computing device 400 includes communication modules 414. The communication modules can include, but are not limited to, a USB communication module 416, a WiFi communication module 418, a Bluetooth communication module 420, a transceiver 422, and an Ethernet (e.g., IEEE 802.3) communication module 424. The communication modules 414 can be used to establish connections and communications between the computing device 400 and one or more external networks and/or devices.

In addition or in the alternative, the computing device 400 can use one or more of the communication modules 414 to establish communications with (a connection to) a single display device (e.g., the display device 332 as shown in FIG. 3C) included in the anaglyph HMD device. In some implementations, the computing device 400 can use one or more of the communication modules 414 to establish communications with (a connection to) two display devices (e.g., the first display device 352 and the second display device 362 as shown in FIG. 3D) included in the anaglyph HMD device. In some implementations, a connector included on the computing device 400 can connect to/interface with a connector included on a single display device (e.g., the display device 332 as shown in FIG. 3C) included in the anaglyph HMD device. In some implementations, one or more connectors included on the computing device 400 can connect to/interface with connectors included on two display devices (e.g., the first display device 352 and the second display device 362 as shown in FIG. 3D) included in the anaglyph HMD device. Connecting/interfacing the computing device 400 to one or more display devices not included on the computing device 400 allows the computing device 400 (e.g., the display interface) to provide image data and information for display on the one or more display devices not included on the computing device 400.

The computing device 400 can include a central processing unit (CPU) 402 and a graphics processing unit (GPU) 404. The CPU 402 can include one or more processors that can perform general computing operations for the computing device 400. For example, the CPU 402 can execute (run) one or more applications (e.g., a VR application 440) on the computing device 400. The one or more applications can be included in (stored in) a memory (e.g., memory 426). The GPU 404 can include one or more processors that can perform graphics-specific operations on the computing device 400 such as image drawing, scaling, and rotation. For example, the GPU 404 can execute (run) one or more applications on the computing device 400. The GPU 404 can prepare image data and information for input to a display interface 412 for subsequent displaying on a display device (e.g., the screen 410).

A color image separator 430 can separate an image into one or more color components. The color image separator 430 can include one or more applications (software program) stored in the memory 426. In some implementations, the GPU 404 and/or the CPU 402 can run (execute) the one or more applications. The color image separator 430 can receive data representative of an image that includes multiple color components (e.g., a color image with red, green, and blue components). The color image separator 430 can separate the image data into two separate images that can be superimposed to recreate (generate) the original image. The color image separator 430 can separate the image data into a first image in a first color and a second image in a second color. The color image separator 430 can provide the data representative of the first image and the data representative of the second image to the display interface 412.

The display interface 412 can prepare data representative of the first image for display on a display device. The display interface 412 can prepare data representative of the second image for display on a display device. As described herein, the display interface 412 can provide the data representative of the first image and the data representative of the second image to the screen 410 in implementations where the screen 410 is the display device for an anaglyph HMD device. In implementations where the display device for the anaglyph HMD device is not included in the computing device 400, the display interface 412 can provide the data representative of the first image and the data representative of the second image to a screen or display device external to the computing device 400. In implementations that include two display devices, the display interface 412 can provide the data representative of the first image to a first display device. The display interface 412 can provide the data representative of the second image to a second display device.

A single pixel rendered (displayed) on a subpixelated display device (e.g., a liquid crystal display (LCD) device, an organic light-emitting diode (OLED) display device) can include multiple color elements that appear as a single color when viewed by the eyes of a user. Each subpixel included in the single pixel can be of a particular color and/or shape (geometry).

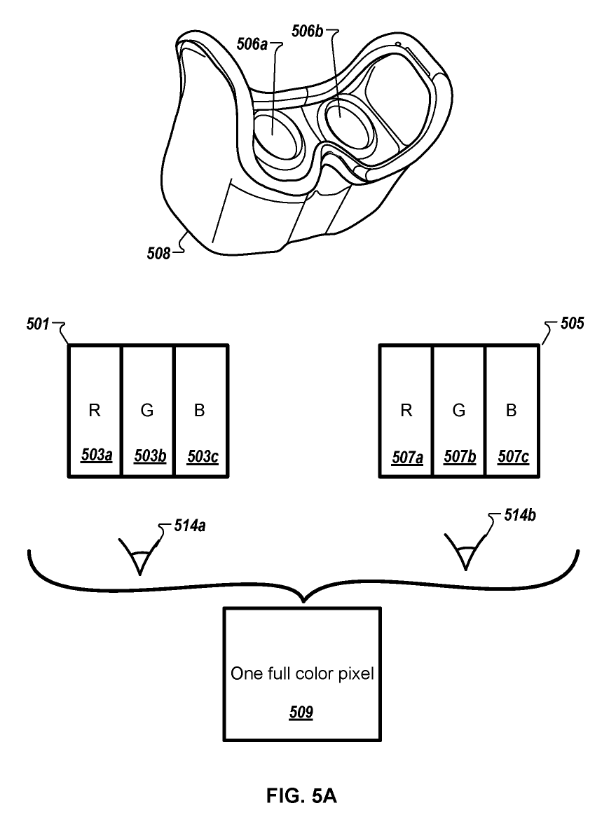

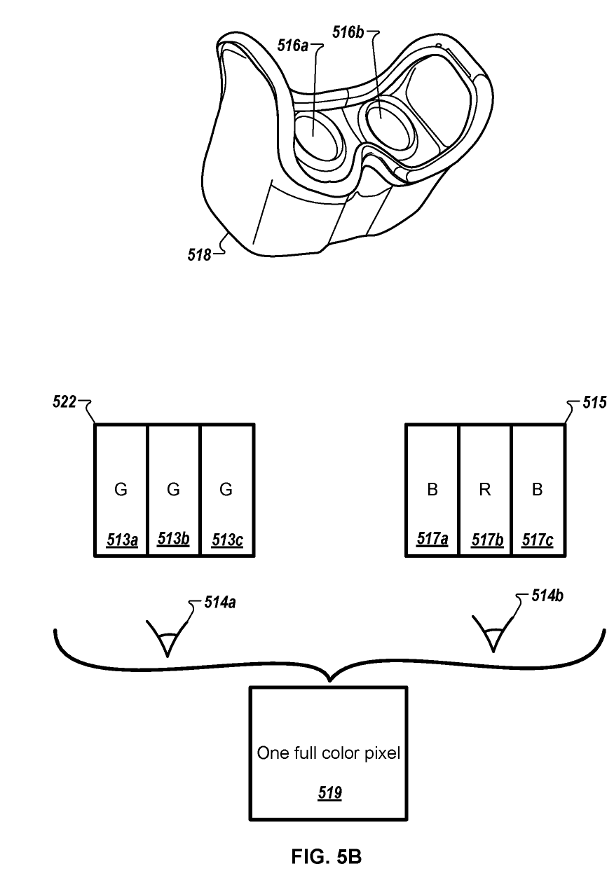

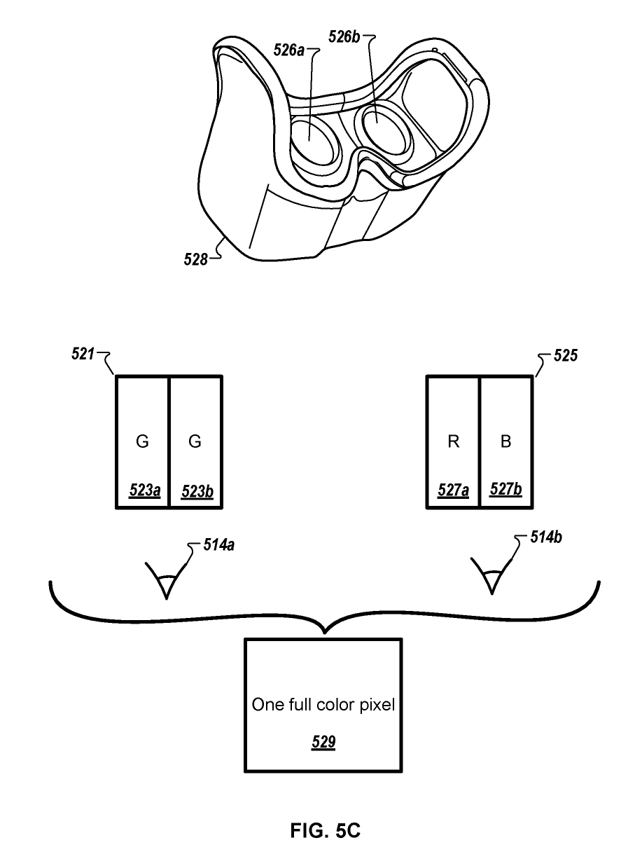

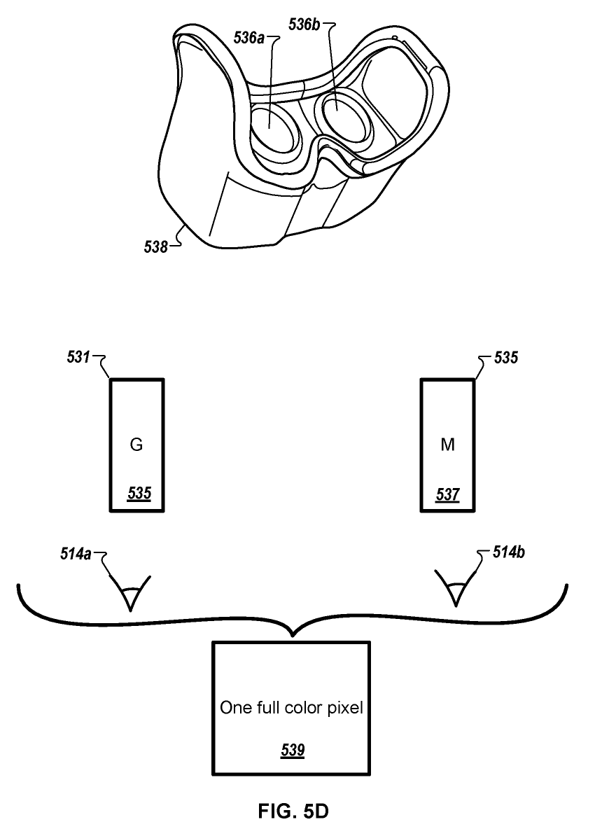

FIGS. 5A-D illustrate subpixels for a first color pixel and a second color pixel for display on a display device included in an anaglyph HMD device where the subpixels are arranged in a stripe pattern.

Though the subpixels included in the pixels in the examples shown in FIGS. 5A-D are shown as rectangular in shape (e.g., as color stripes), in some implementations the subpixels included in a pixel can be a different shape (e.g., a square). The shape of the subpixels included in the pixels in the examples shown in FIGS. 5A-D is shown as an example representation for the subpixels.

Referring to FIG. 5A, a first pixel 501 includes a subpixel 503a (e.g., a red color stripe), a subpixel 503b (e.g., a green color stripe), and a subpixel 503c (e.g., a blue color stripe). A second pixel 505 includes a subpixel 507a (e.g., a red color stripe), a subpixel 507b (e.g., a green color stripe), and a subpixel 507c (e.g., a blue color stripe). In some implementations, as described herein, the first pixel 501 can be presented (displayed) on a first display device included in a first monocular 506a of an anaglyph HMD device 508. The second pixel 505 can be presented (displayed) on a second display device included in a second monocular 506b of the anaglyph HMD device 508. In some implementations, as described herein, the first pixel 501 can be presented (displayed) on a first half (or side) of a single display device included in the anaglyph HMD device 508. The second pixel 505 can be presented (displayed) on a second half (or side) of the single display device included in the anaglyph HMD device 508.

Eyes 514a-b of a user can simultaneously view the first pixel 501 and the second pixel 505. The user will see a single full color pixel 509 (e.g., a white pixel) with a stereoscopic 3D effect. A visual cortex of a brain of the user viewing the first pixel 501 and the second pixel 505 through associated optics included in each of the first monocular 506a and the second monocular 506b, respectively, can fuse or combine (overlay, overlap) the first pixel 501 and the second pixel 505 into a perception of the original image pixel in a VR space.

In the example shown in FIG. 5A, a resolution of the perceived single full color pixel 509 can be determined by each subpixel included in each pixel. A display device that provides the first pixel 501 can be a three-color display device. A display device that provides the second pixel 505 can be a three-color display device. For example, a three-color display device can be an LCD device. The LCD device can include color filters that provide the stripe subpixel pattern as shown in FIG. 5A. For example, a three-color display device can be an OLED display device. In some implementations, the OLED display device can include color filters that provide the stripe subpixel pattern as shown in FIG. 5A. In some implementations, an OLED display device can be fabricated by depositing red, green, and blue material on a substrate in the stripe subpixel pattern as shown in FIG. 5A.

Referring to FIG. 5B, a first pixel 511 includes a subpixel 513a (e.g., first green color stripe), a subpixel 513b (e.g., a second green color stripe), and a subpixel 513c (e.g., a third green color stripe). A second pixel 515 includes a subpixel 517a (e.g., a first blue color stripe), a subpixel 517b (e.g., a red color stripe), and a subpixel 517c (e.g., a second blue color stripe). In some implementations, for example, the subpixel 517a can be a first red color stripe, the subpixel 517b can be a blue color stripe, and the subpixel 517c can be a second red color stripe. In some implementations, as described herein, the first pixel 511 can be presented (displayed) on a first display device included in a first monocular 516a of an anaglyph HMD device 518. The second pixel 515 can be presented (displayed) on a second display device included in a second monocular 516b of the anaglyph HMD device 508.

The eyes 514a-b of a user can simultaneously view the first pixel 511 and the second pixel 515. The user will see a single full color pixel 519 (e.g., a white pixel) with a stereoscopic 3D effect. A visual cortex of a brain of the user viewing the first pixel 511 and the second pixel 515 through associated optics included in each of the first monocular 516a and the second monocular 516b, respectively, can fuse or combine (overlay, overlap) the first pixel 511 and the second pixel 515 into a perception of the original image pixel in a VR space.

In the example shown in FIG. 5B, a resolution of the perceived single full color pixel 519 can be determined by each subpixel included in each pixel. A display device that provides the first pixel 511 can be a single-color (e.g., green) display device. A display device that provides the second pixel 515 can be a two-color (e.g., red and blue) display device. For example, a display device that provides the first pixel 511 can be an LCD device that can include single color filters that provide the stripe subpixel pattern as shown in FIG. 5B. In another example, a display device that provides the first pixel 511 can be an LCD device or an OLED display device that has a green backlight and no filters. In some implementations, a display device that provides the first pixel 511 can be an OLED display device fabricated by depositing green material on a substrate to form the stripe subpixel pattern as shown in FIG. 5B.

For example, a display device that provides the second pixel 515 can be an LCD device that can include two different color filters that provide the stripe subpixel pattern as shown in FIG. 5B. For example, a display device that provides the second pixel 515 can be an OLED display device. In some implementations, the OLED display device can include two different color filters that provide the stripe subpixel pattern as shown in FIG. 5B. In some implementations, an OLED display device can be fabricated by depositing red and blue material on a substrate in the stripe subpixel pattern as shown in FIG. 5B.

Referring to both FIG. 5A and FIG. 5B, the subpixels 513a-c can provide three times the green resolution in an image as compared to the subpixels 503a-c. The anaglyph HMD device 518 can provide a full color image with three times the green resolution as compared to the full color image as provided by the anaglyph HMD device 508. Because the eyes 514a-b of a user can be more sensitive to (receptive to) the color green, providing an increase in the number of green subpixels can effectively increase the perceived resolution of an image.

The anaglyph HMD device 518 can include display devices that are simpler than the display devices included in (incorporated in) the anaglyph HMD device 508. As described, a single color and a two-color display device can be used as compared to two three-color display devices. In some implementations, the single color display device need not have any filters, simplifying fabrication of the display device and improving light output while decreasing power consumption.

Referring to FIG. 5C, a first pixel 521 includes a subpixel 523a (e.g., first green color stripe) and a subpixel 523b (e.g., a second green color stripe). A second pixel 525 includes a subpixel 527a (e.g., a red color stripe) and a subpixel 527b (e.g., a blue color stripe). In some implementations, for example, the subpixel 527a can be a blue color stripe and the subpixel 527b can be a red color stripe. In some implementations, as described herein, the first pixel 521 can be presented (displayed) on a first monocular 526a of an anaglyph HMD device 528. The second pixel 525 can be presented (displayed) on a second display device included in a second monocular 526b of the anaglyph HMD device 528.

The eyes 514a-b of a user can simultaneously view the first pixel 521 and the second pixel 525. The user will see a single full color pixel 529 (e.g., a white pixel) with a stereoscopic 3D effect. A visual cortex of a brain of the user viewing the first pixel 521 and the second pixel 525 through associated optics included in each of the first monocular 526a and the second monocular 526b, respectively, can fuse or combine (overlay, overlap) the first pixel 521 and the second pixel 525 into a perception of the original image pixel in a VR space.

In the example shown in FIG. 5C, a resolution of the perceived single full color pixel 529 can be determined by each subpixel included in each pixel. A display device that provides the first pixel 521 can be a single-color (e.g., green) display device. A display device that provides the second pixel 525 can be a two-color (e.g., red and blue) display device. For example, a display device that provides the first pixel 521 can be an LCD device that can include single color filters that provide the stripe subpixel pattern as shown in FIG. 5C. In another example, a display device that provides the first pixel 521 can be an LCD device or an OLED display device that has a green backlight and no filters. In some implementations, a display device that provides the first pixel 521 can be an OLED display device fabricated by depositing green material on a substrate to form the stripe subpixel pattern as shown in FIG. 5C.

For example, a display device that provides the second pixel 525 can be an LCD device that can include two different color filters that provide the stripe subpixel pattern as shown in FIG. 5C. For example, a display device that provides the second pixel 525 can be an OLED display device. In some implementations, the OLED display device can include two different color filters that provide the stripe subpixel pattern as shown in FIG. 5B. In some implementations, an OLED display device can be fabricated by depositing red and blue material on a substrate in the stripe subpixel pattern as shown in FIG. 5C.

Referring to both FIG. 5A and FIG. 5C, the subpixels 523a-b can provide twice the green resolution in an image as compared to the subpixels 503a-c. The anaglyph HMD device 528 can provide a full color image with twice the green resolution as compared to the full color image as provided by the anaglyph HMD device 508 while providing fewer subpixels per pixel. Because the eyes 514a-b of a user can be more sensitive to (receptive to) the color green, providing an increase in the number of green subpixels can effectively increase the perceived resolution of an image.

The anaglyph HMD device 528 can include display devices that are simpler than the display devices incorporated into the anaglyph HMD device 508 and into the anaglyph HMD device 528. As described, a single color and a two-color display device can be used as compared to two three-color display devices. In some implementations, the single color display device need not have any filters, simplifying fabrication of the display device and improving light output while decreasing power consumption. In addition, as compared to the anaglyph HMD device 518 as shown in FIG. 5B, the anaglyph HMD device 528 can provide fewer subpixels per pixel resulting in, for example, a less expensive display device and/or a smaller display device.

Referring to FIG. 5D, a first pixel 531 includes a subpixel 533 (e.g., a green color stripe). A second pixel 535 includes a subpixel 537 (e.g., a magenta (red plus blue) color stripe). In some implementations, as described herein, the first pixel 531 can be presented (displayed) on a first monocular 536a of an anaglyph HMD device 538. The second pixel 535 can be presented (displayed) on a second display device included in a second monocular 536b of the anaglyph HMD device 538.

The eyes 514a-b of a user can simultaneously view the first pixel 531 and the second pixel 535. The user will see a single full color pixel 539 (e.g., a white pixel) with a stereoscopic 3D effect. A visual cortex of a brain of the user viewing the first pixel 531 and the second pixel 535 through associated optics included in each of the first monocular 536a and the second monocular 536b, respectively, can fuse or combine (overlay, overlap) the first pixel 531 and the second pixel 535 into a perception of the original image pixel in a VR space.

In the example shown in FIG. 5D, a resolution of the perceived single full color pixel 539 can be determined by each subpixel included in each pixel. A display device that provides the first pixel 531 can be a single-color (e.g., green) display device. A display device that provides the second pixel 535 can also be considered a single color (e.g., magenta) display device. In some implementations, a display device that provides the first pixel 531 can be an OLED display device fabricated by depositing green material on a substrate to form the stripe subpixel as shown in FIG. 5D. A display device that provides the second pixel 535 can be an OLED display device fabricated by depositing magenta material on a substrate to form the stripe subpixel as shown in FIG. 5D.

The anaglyph HMD device 538 can include display devices that are simpler than the display devices incorporated into the anaglyph HMD device 508, the anaglyph HMD device 518, and the anaglyph HMD device 528 because of the use of two single color display devices. In some implementations, a single color display device need not have any filters because the material used to fabricate the device can be of the particular color. In addition, referring to FIGS. 5A-C, as compared to the anaglyph HMD device 508, the anaglyph HMD device 518, and the anaglyph HMD device 528, respectively, the anaglyph HMD device 538 can provide fewer subpixels per pixel resulting in, for example, a less expensive display device and/or a smaller display device and/or a higher resolution display device in the same size or footprint. In addition, the design and fabrication of a display device can be simplified reducing an amount of pixel and subpixel crosstalk.

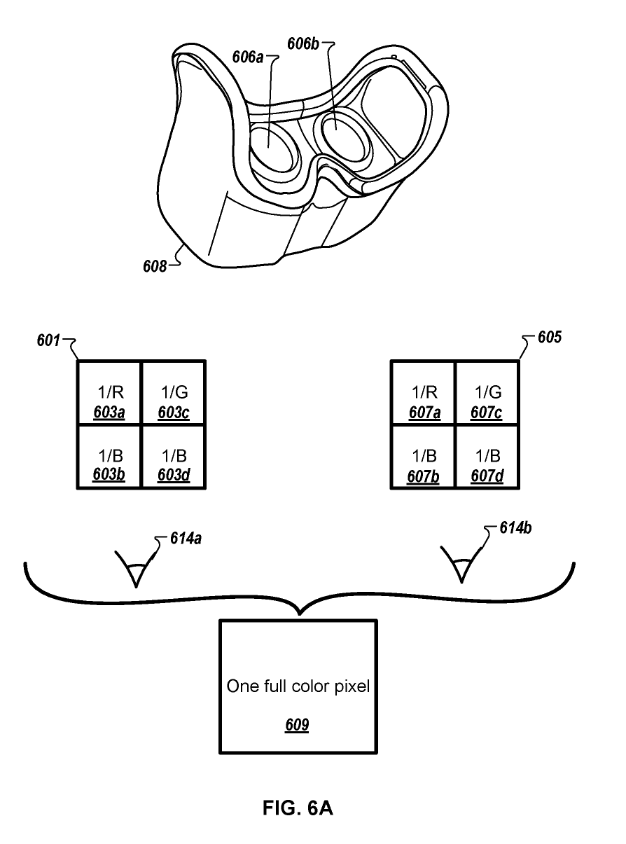

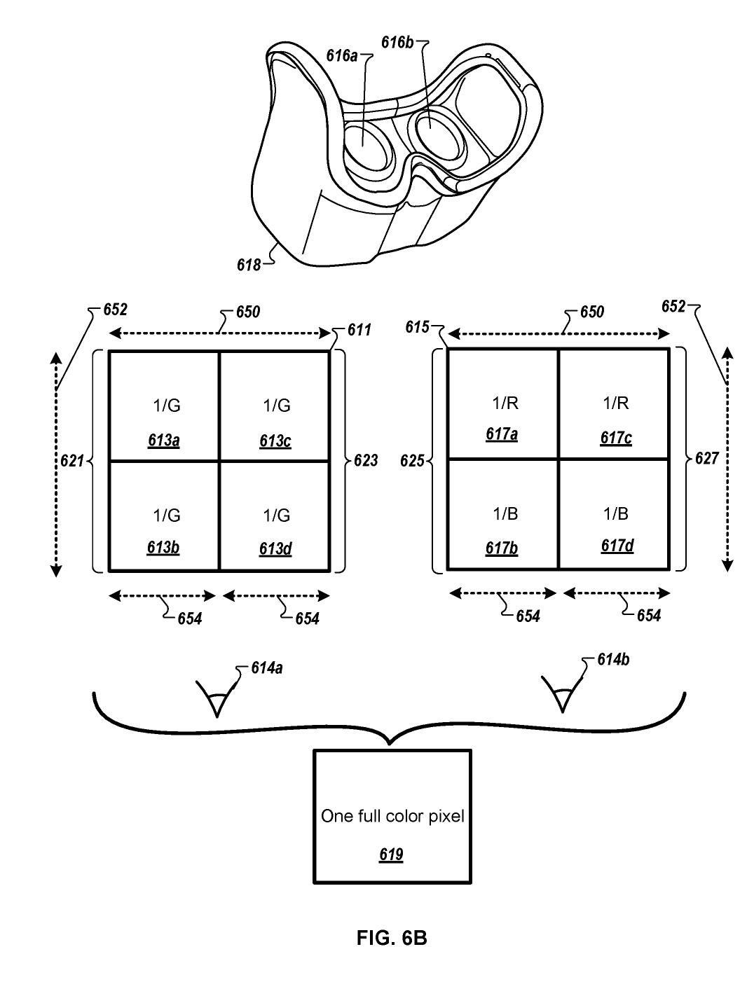

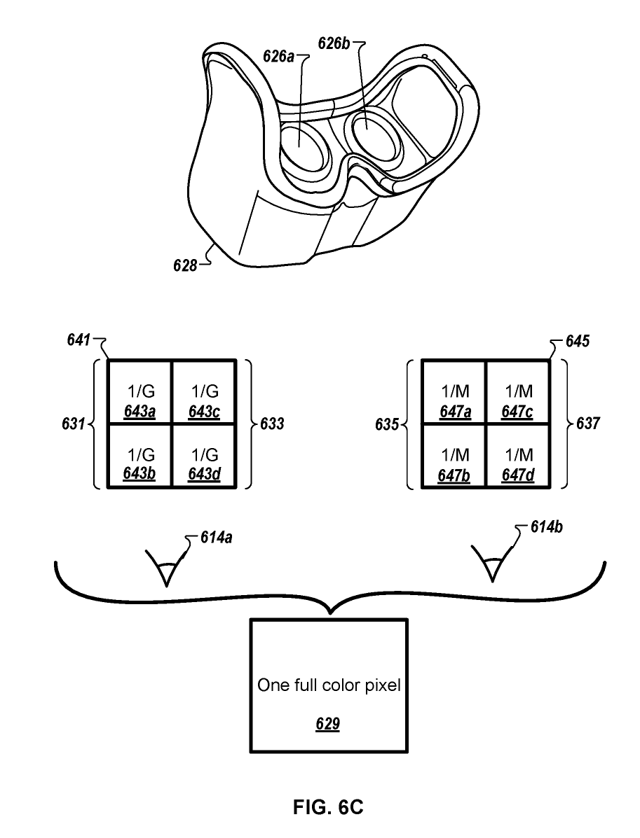

FIGS. 6A-C illustrate subpixels for a first color pixel and a second color pixel for display on a display device included in an anaglyph HMD device where the subpixels are arranged in a quad pattern. Though the subpixels included in the pixels in the examples shown in FIGS. 6A-C are shown as square in shape, in some implementations the subpixels included in a pixel can be a different shape (e.g., a rectangle). The shape of the subpixels included in the pixels in the examples shown in FIGS. 6A-C is shown as an example representation for the subpixels.

Referring to FIG. 6A, a first quad pixel 601 includes a subpixel 603a (e.g., a red subpixel), a subpixel 603b (e.g., a first blue subpixel), a subpixel 603c (e.g., a green subpixel), and a subpixel 603d (e.g., a second blue subpixel). A second quad pixel 605 includes a subpixel 607a (e.g., a red subpixel), a subpixel 607b (e.g., a first blue subpixel), a subpixel 607c (e.g., a green subpixel), and a subpixel 607d (e.g., a second blue subpixel). In some implementations, as described herein, the first quad pixel 601 can be presented (displayed) on a first display device included in a first monocular 606a of an anaglyph HMD device 608. The second quad pixel 605 can be presented (displayed) on a second display device included in a second monocular 606b of the anaglyph HMD device 608. In some implementations, as described herein, the first quad pixel 601 can be presented (displayed) on a first half (or side) of a single display device included in the anaglyph HMD device 608. The second quad pixel 605 can be presented (displayed) on a second half (or side) of the single display device included in the anaglyph HMD device 608.

Eyes 614a-b of a user can simultaneously view the first quad pixel 601 and the second quad pixel 605. The user will see a single full color pixel 609 (e.g., a white pixel) with a stereoscopic 3D effect. A visual cortex of a brain of the user viewing the first quad pixel 601 and the second quad pixel 605 through associated optics included in each of the first monocular 606a and the second monocular 606b, respectively, can fuse or combine (overlay, overlap) the first quad pixel 601 and the second quad pixel 605 into a perception of the original image pixel in a VR space.

In the example shown in FIG. 6A, a resolution of the perceived single full color pixel 609 can be determined by each subpixel included in each pixel. A display device that provides the first quad pixel 601 can be a three-color display device. A display device that provides the second quad pixel 605 can be a three-color display device. For example, a three-color display device can be an LCD device. The LCD device can include color filters that provide the quad subpixel pattern as shown in FIG. 6A. For example, a three-color display device can be an OLED display device. In some implementations, the OLED display device can include color filters that provide the quad subpixel pattern as shown in FIG. 6A. In some implementations, an OLED display device can be fabricated by depositing red, green, and blue material on a substrate in the quad subpixel pattern as shown in FIG. 6A.

In some implementations, the subpixel 603d and the subpixel 607d can be a white subpixel (e.g., no filter is provided allowing a white backlight in the display device through without being filtered). In some implementations, the subpixel 603d and the subpixel 607d can be a yellow (e.g., red plus green) subpixel (e.g., a display device can include a yellow color filter).

Referring to FIG. 6B, a first quad pixel 611 includes a quad subpixels 613a-d (e.g., four green subpixels). A second quad pixel 615 includes subpixels 617a, 617c (e.g., two red subpixels) and subpixels 617b, 617d (e.g., two blue subpixels). In some implementations, the subpixels 617a, 617c can be two blue subpixels, and the subpixels 617b, 617d can be two red subpixels. In some implementations, the subpixels 617a, 617c can be two red subpixels, and the subpixels 617b, 617d can be two blue subpixels. In some implementations, the subpixels 617a, 617c can be two blue subpixels, and the subpixels 617b, 617d can be two red subpixels.

In some implementations, as described herein, the first quad pixel 611 can be presented (displayed) on a first display device included in a first monocular 616a of an anaglyph HMD device 618. The second quad pixel 615 can be presented (displayed) on a second display device included in a second monocular 616b of the anaglyph HMD device 608.

The eyes 614a-b of a user can simultaneously view the first quad pixel 611 and the second quad pixel 615. The user will see a single full color pixel 619 (e.g., a white pixel) with a stereoscopic 3D effect. A visual cortex of a brain of the user viewing the first quad pixel 611 and the second quad pixel 615 through associated optics included in each of the first monocular 616a and the second monocular 616b, respectively, can fuse or combine (overlay, overlap) the first quad pixel 611 and the second quad pixel 615 into a perception of the original image pixel in a VR space.

In the example shown in FIG. 6B, a resolution of the perceived single full color pixel 619 can be determined by each subpixel included in each pixel. A display device that provides the first quad pixel 611 can be a single-color (e.g., green) display device. A display device that provides the second quad pixel 615 can be a two-color (e.g., red and blue) display device. For example, a display device that provides the first quad pixel 611 can be an LCD device that can include single color filters that provide the quad subpixel pattern as shown in FIG. 6B. In another example, a display device that provides the first quad pixel 611 can be an LCD device or an OLED display device that has a green backlight and no filters. In some implementations, a display device that provides the first quad pixel 611 can be an OLED display device fabricated by depositing green material on a substrate to form the quad subpixel pattern as shown in FIG. 6B.

For example, a display device that provides the second quad pixel 615 can be an LCD device that can include two different color filters that provide the quad subpixel pattern as shown in FIG. 6B. For example, a display device that provides the second quad pixel 615 can be an OLED display device. In some implementations, the OLED display device can include two different color filters that provide the quad subpixel pattern as shown in FIG. 6B. In some implementations, an OLED display device can be fabricated by depositing red and blue material on a substrate in the quad subpixel pattern as shown in FIG. 6B.

Referring to FIG. 6A and FIG. 6B, the subpixels 613a-d can provide four times the green resolution in an image as compared to the subpixels 603a-d. The anaglyph HMD device 618 can provide a full color image with four times the green resolution as compared to the full color image as provided by the anaglyph HMD device 608. Because the eyes 614a-b of a user can be more sensitive to (receptive to) the color green, providing an increase in the number of green subpixels can effectively increase the perceived resolution of an image.

In some implementations, referring to FIG. 6B, two of the four subpixels included in each quad pixel 611, 615 can be considered a pixel. In some implementations, for example, a first pixel 621 can include subpixels 613a-b and a second pixel 623 can include subpixels 613c-d. A third pixel 625 can include subpixels 617a-b and a fourth pixel 627 can include subpixels 617c-d. As described herein, the first pixel 621 and the second pixel 623 can be presented (displayed) on a first display device included in the first monocular 616a of the anaglyph HMD device 618. The third pixel 625 and the fourth pixel 627 can be presented (displayed) on a second display device included in a second monocular 616b of the anaglyph HMD device 618. The eyes 614a-b of a user can simultaneously view the first pixel 621 and the third pixel 625. A visual cortex of a brain of the user viewing the first pixel 621 and the third pixel 625 through associated optics included in each of the first monocular 616a and the second monocular 616b, respectively, can fuse or combine (overlay, overlap) the first pixel 621 and the third pixel 625 into a perception of the original image pixel in a VR space. The eyes 614a-b of a user can simultaneously view the second pixel 623 and the fourth pixel 627. A visual cortex of a brain of the user viewing the second pixel 623 and the fourth pixel 627 through associated optics included in each of the first monocular 616a and the second monocular 616b, respectively, can fuse or combine (overlay, overlap) the second pixel 623 and the fourth pixel 627 into a perception of the original image pixel in a VR space.

Referring to FIG. 6A and the implementation of FIG. 6B that includes the first pixel 621, the second pixel 623, the third pixel 625, and the fourth pixel 627, the first pixel 621 (and the second pixel 623) can provide twice the green resolution in an image as compared to the subpixels 603a-d. The anaglyph HMD device 618 can provide a full color image with twice the green resolution as compared to the full color image as provided by the anaglyph HMD device 608. Because the eyes 614a-b of a user can be more sensitive to (receptive to) the color green, providing an increase in the number of green subpixels can effectively increase the perceived resolution of an image.

Referring to the implementation of FIG. 6B that includes the first pixel 621, the second pixel 623, the third pixel 625, and the fourth pixel 627, the anaglyph HMD device 628 can provide a full color image with twice the green resolution as compared to the full color image as provided by the anaglyph HMD device 608 while providing fewer subpixels per pixel. Because the eyes 614a-b of a user can be more sensitive to (receptive to) the color green, providing an increase in the number of green subpixels can effectively increase the perceived resolution of an image.

The anaglyph HMD device 618 can include display devices that are simpler than the display devices included in (incorporated in) the anaglyph HMD device 608. As described, a single color and a two-color display device can be used as compared to two three-color display devices. In some implementations, the single color display device need not have any filters, simplifying fabrication of the display device and improving light output while decreasing power consumption.

In addition, in the implementation of FIG. 6B that includes the first pixel 621, the second pixel 623, the third pixel 625, and the fourth pixel 627, the anaglyph HMD device 618 can provide fewer subpixels per pixel resulting in, for example, a less expensive display device and/or a smaller display device.

Referring to FIG. 6C, a first quad pixel 641 includes quad subpixels 643a-d (e.g., four green subpixels). A second quad pixel 645 includes quad subpixels 647a-d (e.g., four magenta (red plus blue) subpixels). In some implementations, as described herein, the first quad pixel 641 can be presented (displayed) on a first monocular 626a of an anaglyph HMD device 628. The second quad pixel 645 can be presented (displayed) on a second display device included in a second monocular 626b of the anaglyph HMD device 628.

The eyes 614a-b of a user can simultaneously view the first quad pixel 641 and the second quad pixel 645. The user will see a single full color pixel 629 (e.g., a white pixel) with a stereoscopic 3D effect. A visual cortex of a brain of the user viewing the first quad pixel 641 and the second quad pixel 645 through associated optics included in each of the first monocular 626a and the second monocular 626b, respectively, can fuse or combine (overlay, overlap) the first quad pixel 641 and the second quad pixel 645 into a perception of the original image pixel in a VR space.

In the example shown in FIG. 6C, a resolution of the perceived single full color pixel 629 can be determined by each subpixel included in each quad pixel. A display device that provides the first quad pixel 641 can be a single-color (e.g., green) display device. A display device that provides the second quad pixel 645 can also be a single-color (e.g., magenta) display device. For example, a display device that provides the first quad pixel 641 can be an LCD device or an OLED display device that has a green backlight and no filters. A display device that provides the second quad pixel 645 can be an LCD device or an OLED display device that has a magenta backlight (e.g., red plus blue) and no filters. In some implementations, a display device that provides the first quad pixel 641 can be an OLED display device fabricated by depositing green material on a substrate to form the quad subpixel pattern as shown in FIG. 6C. A display device that provides the second quad pixel 645 can be an OLED display device fabricated by depositing magenta (e.g., red plus blue) material on a substrate to form the quad subpixel pattern as shown in FIG. 6C.

Referring to both FIG. 6A and FIG. 6C, the quad subpixels 641a-d can provide four times the green resolution in an image as compared to the subpixels 645a-d. The anaglyph HMD device 628 can provide a full color image with four times the green resolution as compared to the full color image as provided by the anaglyph HMD device 608 while providing the same number of subpixels per pixel. Because the eyes 614a-b of a user can be more sensitive to (receptive to) the color green, providing an increase in the number of green subpixels can effectively increase the perceived resolution of an image.

In some implementations, referring to FIG. 6C, two of the four subpixels included in each quad pixel 641, 645 can be considered a pixel. In some implementations, for example, a first pixel 631 can include subpixels 643a-b and a second pixel 633 can include subpixels 643c-d. A third pixel 635 can include subpixels 647a-b and a fourth pixel 637 can include subpixels 647c-d. As described herein, the first pixel 631 and the second pixel 633 can be presented (displayed) on a first display device included in the first monocular 626a of the anaglyph HMD device 628. The third pixel 635 and the fourth pixel 637 can be presented (displayed) on a second display device included in a second monocular 626b of the anaglyph HMD device 628. The eyes 614a-b of a user can simultaneously view the first pixel 631 and the third pixel 635. A visual cortex of a brain of the user viewing the first pixel 631 and the third pixel 635 through associated optics included in each of the first monocular 616a and the second monocular 616b, respectively, can fuse or combine (overlay, overlap) the first pixel 631 and the third pixel 635 into a perception of the original image pixel in a VR space. The eyes 614a-b of a user can simultaneously view the second pixel 633 and the fourth pixel 637. A visual cortex of a brain of the user viewing the second pixel 633 and the fourth pixel 637 through associated optics included in each of the first monocular 616a and the second monocular 616b, respectively, can fuse or combine (overlay, overlap) the second pixel 633 and the fourth pixel 637 into a perception of the original image pixel in a VR space.

Referring to FIG. 6A and the implementation of FIG. 6C that includes the first pixel 631, the second pixel 633, the third pixel 635, and the fourth pixel 637, the first pixel 631 (and the second pixel 633) can provide twice the green resolution in an image as compared to the subpixels 603a-d. The anaglyph HMD device 628 can provide a full color image with twice the green resolution as compared to the full color image as provided by the anaglyph HMD device 608. Because the eyes 614a-b of a user can be more sensitive to (receptive to) the color green, providing an increase in the number of green subpixels can effectively increase the perceived resolution of an image.

Referring to the implementation of FIG. 6C that includes the first pixel 631, the second pixel 633, the third pixel 635, and the fourth pixel 637, the anaglyph HMD device 628 can provide a full color image with twice the green resolution as compared to the full color image as provided by the anaglyph HMD device 608 while providing fewer subpixels per pixel. Because the eyes 614a-b of a user can be more sensitive to (receptive to) the color green, providing an increase in the number of green subpixels can effectively increase the perceived resolution of an image.

Referring to FIGS. 6A-C, the anaglyph HMD device 628 can include display devices that are simpler than the display devices included in (incorporated in) the anaglyph HMD device 608 and display devices that are simpler than the display devices included in (incorporated in) the anaglyph HMD device 618. As described, single color display devices can be included in (incorporated in) the anaglyph HMD device 628 as compared to the use of at least one two-color display device in the anaglyph HMD device 628 and the use of two three-color display devices in the anaglyph HMD device 608. In some implementations, the single color display device need not have any filters, simplifying fabrication of the display device and improving light output while decreasing power consumption.

In addition, in the implementation of FIG. 6C that includes the first pixel 631, the second pixel 633, the third pixel 635, and the fourth pixel 637, the anaglyph HMD device 628 can provide fewer subpixels per pixel resulting in, for example, a less expensive display device and/or a smaller display device. In addition, the design and fabrication of a display device can be simplified reducing an amount of pixel and subpixel crosstalk. In some implementations, each quad subpixel 643a-d and 647a-d can be considered a single pixel.

Referring to FIGS. 5A-D and FIGS. 6A-C, in some implementations, the pixel 511, the pixel 521, and the pixel 611 can include red subpixels. In these implementations, the pixel 515, the pixel 525, and the pixel 615, respectively, can include green and blue subpixels. In some implementations, the pixel 511, the pixel 521, and the pixel 611 can include red and blue subpixels. In these implementations, the pixel 515, the pixel 525, and the pixel 615, respectively, can include green and blue subpixels.

In some implementations, the pixel 531 and the pixel 641 can include red subpixel(s). In these implementations, the pixel 535 and the pixel 645, respectively, can include cyan (green plus blue) subpixels. In some implementations, the pixel 531 and the pixel 641 can include magenta (red plus blue) subpixels. In these implementations, the pixel 535 and the pixel 645, respectively, can include cyan (green plus blue) subpixels.

For example, referring to FIGS. 5A-D, electronics (circuitry) included in the anaglyph HMD device 518, the anaglyph HMD device 528, and the anaglyph HMD device 538 can be reduced by approximately fifty percent as compared to the electronics (circuitry) included in the anaglyph HMD device 508. The anaglyph HMD device 508 includes two three-color display devices. Each display device utilizes 24-bits to address the three color components of 8-bits each for each display device resulting in the need for 48-bits to address the color components for the anaglyph HMD device 508. For example, the display device providing the single color pixel (e.g., pixel 511) included in the anaglyph HMD device 518 is addressed using 8-bits. The display device providing the two-color pixel (e.g., pixel 515) included in the anaglyph HMD device 518 is addressed using 16-bits. In total, 24-bits are needed to address the color components for the display devices included in the anaglyph HMD device 518. Similar comparisons can be made between the anaglyph HMD device 508 and the anaglyph HMD device 528 and the anaglyph HMD device 538.

For example, referring to FIGS. 6A-C, electronics (circuitry) included in the anaglyph HMD device 618 and the anaglyph HMD device 628 can be reduced by approximately fifty percent as compared to the electronics (circuitry) included in the anaglyph HMD device 608. The anaglyph HMD device 608 includes two three-color display devices. Each display device utilizes 24-bits to address the three color components of 8-bits each for each display device resulting in the need for 48-bits to address the color components for the anaglyph HMD device 608. For example, the display device providing the single color pixel (e.g., pixel 611) included in the anaglyph HMD device 618 is addressed using 8-bits. The display device providing the two-color pixel (e.g., pixel 615) included in the anaglyph HMD device 618 is addressed using 16-bits. In total, 24-bits are needed to address the color components for the display devices included in the anaglyph HMD device 618. Similar comparisons can be made between the anaglyph HMD device 608 and the anaglyph HMD device 628.

The ability to reduce the electronics (circuitry) by approximately fifty percent in anaglyph HMDs that do not include two three color display devices can result in operating an anaglyph HMD device at a higher update rate that does not utilized increased power consumption. Power consumption does not need to be increased because of the fewer number of bits needed to address the color components for the display devices included in the anaglyph HMD device. In addition or in the alternative, a reduction in the number of bits needed to address the color components for the display devices included in an anaglyph HMD device that does not include two three color display devices, as described herein, can simplify the design and type of electronics (circuitry) needed to interface with (drive) the display devices.

Referring to FIGS. 5B-D and FIGS. 6B-C, anaglyph HMDs that include a single color display device can have improved color space because the output spectrum of a single color display device is limited to the single color and can be more easily controlled and fine-tuned as compared to controlling and fine-tuning a three color output spectrum of a three color display device. For example, in cases where the display devices are LCD devices, narrow spectrum green light emitting diodes (LEDs) can be used in a single color green display device (e.g., the display device providing the pixel 511, the pixel 521, the pixel 531, the pixel 611, and the pixel 641). Red LEDs and blue LEDs can be used in a two color display device (e.g., the display device providing the pixel 515, the pixel 525, the pixel 531, and the pixel 615).

In some implementations, a display device can be liquid crystal on silicon (LCOS) display device. A LCOS display device includes a miniaturized reflective active-matrix LCD (a microdisplay) that incorporates a liquid crystal layer on top of a silicon backplane. A LCOS display device can include one display chip per color. Referring to FIGS. 5B-D and FIGS. 6B-C, for example, a single color green display device (e.g., the display device providing the pixel 511, the pixel 521, the pixel 531, the pixel 611, and the pixel 641) can be a LCOS display device that incorporates a single display chip (e.g., a green color display chip). A two color (e.g., blue and red) display device (e.g., the display device providing the pixel 515, the pixel 525, the pixel 531, and the pixel 615) can be a LCOS display device that incorporates a two display chips (e.g., a blue color display chip and a red color display chip). Each display chip included in a LCOS display device can be separately and independently controlled.

Referring to FIGS. 5A-D and FIGS. 6A-C, anaglyph HMDs that include a single color display device and a two color display can have improved visual acuity in a VR space as compared to anaglyph HMDs that utilize a three color display (e.g., the anaglyph HMD device 508 in FIG. 5A, anaglyph HMD device 608 in FIG. 6A). A user wearing an anaglyph HMD device (e.g., the anaglyph HMD device 518, the anaglyph HMD device 528, the anaglyph HMD device 538, the anaglyph HMD device 618, the anaglyph HMD device 628) that includes (incorporates) a single color display device and a two color display views green pixels overlapping magenta (blue plus red) pixels. The overlap can provide an improved point spread function (an improved modulation transfer function (MTF)) in the VR space as compared to the MTF as provided by an anaglyph HMD device (e.g., the anaglyph HMD device 508, the anaglyph HMD device 608) that includes (incorporates) three color display device(s) that provides, for example, three color stripe subpixels per pixel (e.g., the anaglyph HMD device 508). A user wearing an anaglyph HMD device (e.g., the anaglyph HMD device 508, the anaglyph HMD device 608) that includes (incorporates) two three color displays (or a single three color display) views red, green, and blue pixels overlapping red, green, and blue pixels.

For example, referring to FIG. 6B, a VR space can provide a two kilobyte (KB)×two kilobyte (KB) (2 KB×2 KB) resolution image that includes square pixels. A square pixel (e.g., first quad pixel 611, second quad pixel 615) can have a pixel width 650 (e.g., equal to 9.6 microns) and a pixel height 652 (e.g., equal to 9.6 microns). The square pixel (e.g., first quad pixel 611, second quad pixel 615) can include two subpixels (e.g., the first pixel 621 and the second pixel 623, the third pixel 625 and the fourth pixel 627, respectively). Each subpixel (e.g., the first pixel 621 and the second pixel 623, the third pixel 625 and the fourth pixel 627) can be of the pixel height 652 and a subpixel width 654. FIG. 6B shows an example of pixel and subpixel colors, widths and heights. Other examples can have pixels and subpixels of other colors, heights, widths, and arrangements as described herein.

In some implementations, an anaglyph HMD device can include head tracking. The anaglyph HMD device can sense movement of a head of a user wearing the anaglyph HMD device. The head movement translates into movement within the VR space of the anaglyph HMD device. In these implementations, a duty cycle for updating the images displayed on the one or more display devices included in the anaglyph HMD device can be approximately 10% to approximately 30% in order to avoid artifacts on the images.

For example, referring to FIG. 4, a computing device (e.g., the computing device 400) can be included in an anaglyph HMD device. The computing device 400 can include components (circuitry) for controlling OLED display device(s) included in an anaglyph HMD device. The anaglyph HMD device can include a single-color (e.g., green) OLED display device and a two-color (e.g., magenta, red and blue) OLED display device (e.g., the anaglyph HMD device 518, the anaglyph HMD device 528, the anaglyph HMD device 538, the anaglyph HMD device 618, the anaglyph HMD device 628). As described herein, the OLED display devices included in the anaglyph HMD device can be fabricated (formed) by depositing a color material on a substrate. The fabricated OLED display device can include an indium tin oxide (ITO) layer of the OLED display device. These fabricated OLED display devices may not include any color filters. The computing device 400 can interface to and drive the fabricated OLED display devices that do not include any color filters more efficiently than OLED display devices that include color filters. The ability to drive the fabricated OLED display devices more efficiently (e.g., faster, using less power) makes achieving the duty cycle for updating images displayed on the fabricated OLED display device easier. An OLED display device that includes a color filter requires white light backlighting the color filter resulting in the need to provide more drive to the OLED display device in order to achieve the same light output as the fabricated OLED display device.

In another example, referring to FIG. 4, a computing device (e.g., the computing device 400) included in an anaglyph HMD device can include components (circuitry) for controlling LCD device(s) included in an anaglyph HMD device. The anaglyph HMD device can include a single-color (e.g., green) LCD device and a two-color (e.g., magenta, red and blue) LCD device (e.g., the anaglyph HMD device 518, the anaglyph HMD device 528, the anaglyph HMD device 538, the anaglyph HMD device 618, the anaglyph HMD device 628). As described herein, in some implementations, a single color LCD device can be fabricated using a white backlight and a single color filter. In some implementations, the LCD may not include a filter and the color is provided by the light source. The LCD device can include a transparent conductive coating of ITO. For example, in a twisted nematic LCD device, a slow response of the twisted nematic included in the LCD device combined with the ability to pulse (or pulse width modulate (PWM)) the backlight can be used to achieve the duty cycle for updating images displayed on the LCD device. In cases where a response of the LCD device is known by the computing device (e.g., the computing device 400), turning on (enabling) the backlight by the computing device can be performed at the appropriate point in tie and for the needed duration, minimizing power consumption by the LCD device.

In some implementations, in addition or in the alternative, driving a display device that includes ITO can cause a slight heating of the display device. The slight heating can improve the response time of the display device.

Referring to FIGS. 3A-C and FIG. 4, in some implementations, the single display device 332 can be a three-color display device that is part of (included in, integrated in) the mobile computing device 302. In some implementations, the mobile computing device 302 can be placed inside of (within) the anaglyph HMD device 308 when the user wishes to immerse themselves in a VR space. In some implementations, a mobile computing device (e.g., the mobile computing device 302) can be permanently included (incorporated within, housed in) an anaglyph HMD device (e.g., the anaglyph HMD device 308). For example, the computing device 400 can be the mobile computing device 302. The computing device 400 can include components (circuitry) for controlling the three-color display device, providing (displaying) a single color image (e.g., a green image, the first image 340a) in the first half (or side) 336a of the single display device 332. Simultaneously, the computing device 400 can include components (circuitry) for controlling the three-color display device, providing (displaying) a two-color image (e.g., a red plus blue (magenta) image, the second image 340b) in the second half (or side) 336b of the single display device 332. When viewed by a user in the binocular configuration 330, the first image 340a can overlap (overlay) the second image 340b forming a single full color image. Driving the single display device 332 to provide a single color on one half of the display device and two colors on the other half of the display device can reduce power consumed by the single display device 332 (and the mobile computing device 302) when compared to driving the single display device 332 to provide three colors on the entire single display device 332. In addition or in the alternative, because fewer pixels are processed by the mobile computing device 302, components and circuitry included in the mobile computing device 302, the performance requirements of the components and circuity can be reduced.

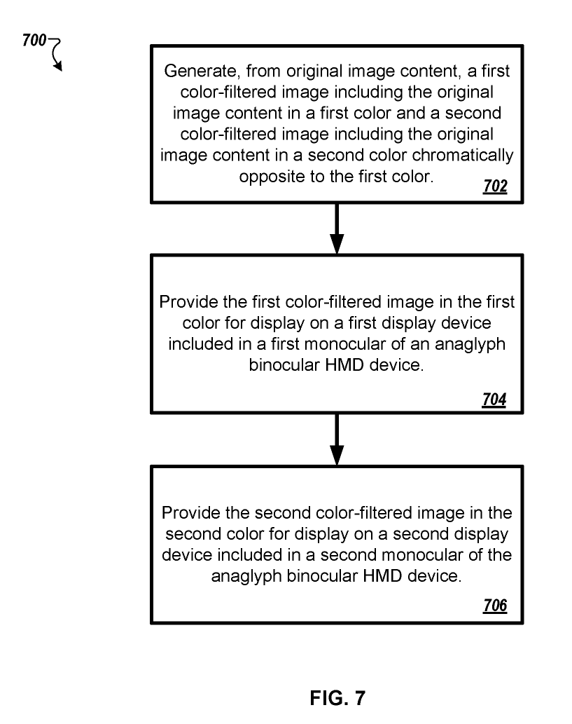

FIG. 7 is a flowchart that illustrates a method 700 of providing image content to an anaglyph binocular HMD device. In some implementations, the systems, methods, and processes described herein can implement the method 700. For example, the method 700 can be described referring to FIGS. 1, 2A-B, 3A-D, 4, 5A-D, and 6A-C.

A computing device generates, from original image content, a first color-filtered image including the original image content in a first color and a second color-filtered image including the original image content in a second color chromatically opposite to the first color (block 702). The computing device provides the first color-filtered image in the first color for display on a first display device included in a first monocular of an anaglyph binocular HMD device (block 704). The computing device provides the second color-filtered image in the second color for display on a second display device included in a second monocular of the anaglyph binocular HMD device (block 706). The first color-filtered image and the second color-filtered image when fused together can provide a perception of the original image content.

For example, referring to FIG. 3D and FIG. 4, the computing device 400 can generate the first image 360a and the second image 360b from an original scene or image. The first image 360a can be displayed on the first display device 352 in a first color (e.g., green). The second image 340b can be displayed on the second display device 362 in a second color (e.g., magenta) that is chromatically opposite to the first color. Each of the first monocular 354a and the second monocular 354b can provide the first image 360a displayed on the first display device 352 and the second image 360b displayed on the second display device 362, respectively, to the first eye 314a and the second eye 314b, respectively, of the user 320 in the binocular configuration 350. A visual cortex of a brain of a user (e.g., the user 320) can fuse or combine the first image 360a provided to the first eye 314a and the second image 360b image provided to the second eye 314b into a perception of a 3D image in the VR space (e.g., a third image 360c). For example, a green first image (e.g., the first image 360a) and a magenta second image (e.g., the second image 360b) combined can form a white third image (e.g., the third image 360c).

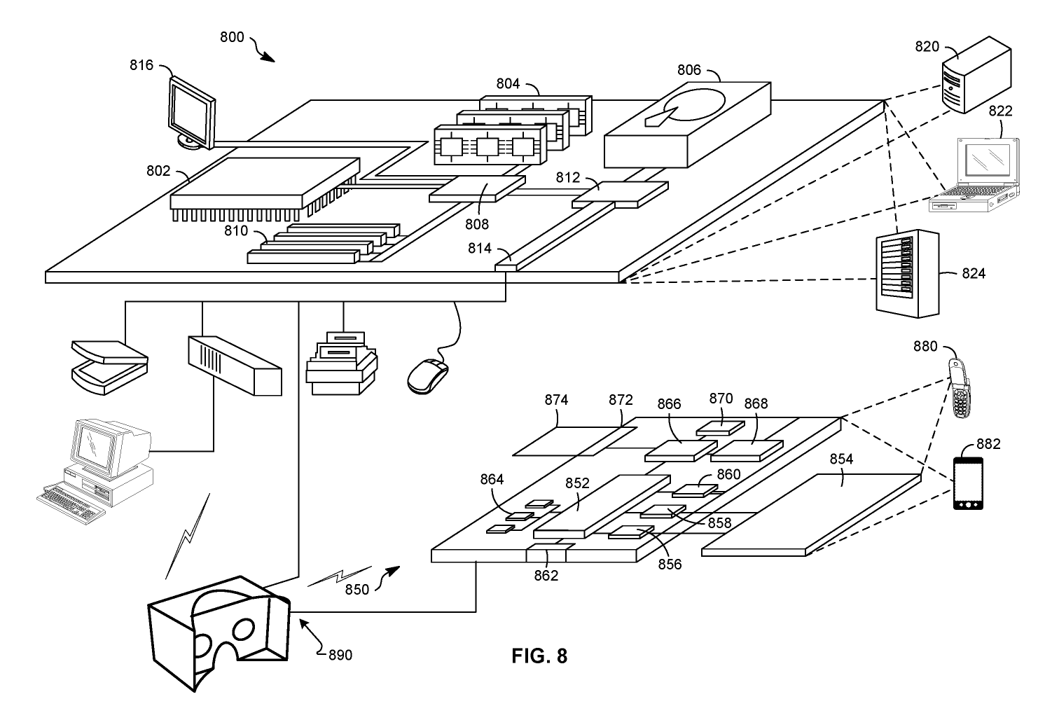

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 8 can include sensors that interface with a virtual reality (HMD device 890). For example, one or more sensors included on a computing device 850 or other computing device depicted in FIG. 6, can provide input to HMD device 890 or in general, provide input to a VR environment. The sensors can include, but are not limited to, a touchscreen, accelerometers, gyroscopes, pressure sensors, biometric sensors, temperature sensors, humidity sensors, and ambient light sensors. The computing device 850 can use the sensors to determine an absolute position and/or a detected rotation of the computing device in the VR environment that can then be used as input to the VR environment. For example, the computing device 850 may be incorporated into the VR environment as a virtual object, such as a controller, a laser pointer, a keyboard, a weapon, etc. Positioning of the computing device/virtual object by the user when incorporated into the VR environment can allow the user to position the computing device to view the virtual object in certain manners in the VR environment. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 850 can be used as input to the VR environment. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 850 when the computing device is incorporated into the VR environment can cause a particular action to occur in the VR environment.

In some implementations, a touchscreen of the computing device 850 can be rendered as a touchpad in VR environment. A user can interact with the touchscreen of the computing device 850. The interactions are rendered, in HMD device 890 for example, as movements on the rendered touchpad in the VR environment. The rendered movements can control objects in the VR environment.

In some implementations, one or more output devices included on the computing device 850 can provide output and/or feedback to a user of the HMD device 890 in the VR environment. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 850 may appear as another object in a computer-generated, 3D environment. Interactions by the user with the computing device 850 (e.g., rotating, shaking, touching a touchscreen, swiping a finger across a touch screen) can be interpreted as interactions with the object in the VR environment. In the example of the laser pointer in a VR environment, the computing device 850 appears as a virtual laser pointer in the computer-generated, 3D environment. As the user manipulates the computing device 850, the user in the VR environment sees movement of the laser pointer. The user receives feedback from interactions with the computing device 850 in the VR environment on the computing device 850 or on the HMD device 890.

In some implementations, a computing device 850 may include a touchscreen. For example, a user can interact with the touchscreen in a particular manner that can mimic what happens on the touchscreen with what happens in the VR environment. For example, a user may use a pinching-type motion to zoom content displayed on the touchscreen. This pinching-type motion on the touchscreen can cause information provided in the VR environment to be zoomed.

In some implementations, one or more input devices in addition to the computing device (e.g., a mouse, a keyboard) can be rendered in a computer-generated, 3D environment. The rendered input devices (e.g., the rendered mouse, the rendered keyboard) can be used as rendered in the VR environment to control objects in the VR environment.

Computing device 800 is intended to represent varying forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

A number of implementations have been described. Nevertheless, it will be understood that various modifications may be made without departing from the spirit and scope of the implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A binocular anaglyph head mounted display (HMD) device comprising:
a first monocular including a first display device and a first optical system, the first display device being a single color display device configured to display image content on the first display device in a first color; and
a second monocular including a second display device and a second optical system, the second display device being a two color display device configured to display image content on the second display device in a second color that is chromatically opposite to the first color.

2. The binocular anaglyph HMD device of claim 1, wherein the first optical system includes a monochrome lens configured to provide the image content in the first color.

3. The binocular anaglyph HMD device of claim 1, wherein the second optical system includes a two-color lens configured to provide the image content in the second color.

4. The binocular anaglyph HMD device of claim 1, wherein the first display device and the second display device are organic light-emitting diode (OLED) display devices.

5. The binocular anaglyph HMD device of claim 1, wherein the first display device and the second display device are liquid crystal display (LCD) devices.

6. The binocular anaglyph HMD device of claim 1, further including a computing device configured to:
generate, from original image content, the image content for display on the first display device in the first color and the image content for display on the second display device in the second color; and
provide the image content for display in the first color to the first display device while providing the image content for display in the second color to the second display device.

7. The binocular anaglyph HMD device of claim 1,
wherein a first pixel displayed on the first display device includes a plurality of first subpixels, and
wherein a second pixel displayed on the second display device includes a plurality of second subpixels.

8. The binocular anaglyph HMD device of claim 7,
wherein the plurality of first subpixels are displayed in the first color,
wherein the second color comprises a third color and a fourth color, and
wherein a first subset of the plurality of second subpixels are displayed in the third color and a second subset of the plurality of second subpixels are displayed in the fourth color.

9. The binocular anaglyph HMD device of claim 8,
wherein the plurality of first subpixels are arranged in a stripe pattern, and
wherein the plurality of second subpixels are arranged in a stripe pattern.

10. The binocular anaglyph HMD device of claim 9, wherein the first color is green, the second color is magenta, the third color is blue, and the fourth color is red.

11. The binocular anaglyph HMD device of claim 8,
wherein the plurality of first subpixels are arranged in a quad pattern, and
wherein the plurality of second subpixels are arranged in a quad pattern.

12. The binocular anaglyph HMD device of claim 11, wherein the first color is green, the second color is magenta, the third color is blue, and the fourth color is red.

13. A method comprising:
generating, by a computing device and from original image content, a first color-filtered image including the original image content in a first color and a second color-filtered image including the original image content in a second color chromatically opposite to the first color;
providing, by the computing device, the first color-filtered image in the first color for display on a first display device included in a first monocular of an anaglyph binocular head mounted display (HMD) device; and
providing, by the computing device, the second color-filtered image in the second color for display on a second display device included in a second monocular of the anaglyph binocular HMD device, the first color-filtered image and the second color-filtered image when fused together providing a perception of the original image content.

14. The method of claim 13, wherein the computing device provides the first color-filtered image in the first color for display on the first display device simultaneously with providing the second color-filtered image in the second color for display on the second display device.

15. The method of claim 14, wherein fusing together the first color-filtered image and the second color-filtered image includes overlapping the first color-filtered image and the second color-filtered image.

16. The method of claim 13, wherein the first color is green, the second color is magenta.

17. A system comprising:
a first display device configured to display image content in a first color;
a second display device configured to display image content in a second color chromatically opposite to the first color; and
a computing device including:
an image color separator configured to generate, from original image content, a first color-filtered image including the original image content in the first color and a second color-filtered image including the original image content in the second color chromatically opposite to the first color; and
a display interface configured to provide the first color-filtered image for display on the first display device while providing the second color-filtered image for display on the second display device, the first color-filtered image when fused with the second color-filtered image providing a perception of the original image content.

18. The system of claim 17,
wherein the first display device and the second display device are a single display device, and
wherein the display interface is further configured to provide the first color-filtered image for display on a first half of the single display device while providing the second color-filtered image for display on a second half of the single display device.

19. The system of claim 18, further comprising:
a first optical system; and
a second optical system, wherein the first optical system is configured to provide the displayed first color-filtered image for fusing with the displayed second color-filtered image provided by the second optical system.

20. The system of claim 19,
wherein the system is a head mounted display (HMD) device,
wherein the computing device is a mobile computing device, and
wherein the single display device is a screen of the mobile computing device.
